(19) United States
(12) Patent Application Publication
(10) Pub. No.: US 2023/0182397 A1
(43) Pub. Date: Jun. 15, 2023

(54) WORKFLOW FOR LAYER-LESS MULTI-AXIS MATERIAL EXTRUSION

(71) Applicant: VIRGINIA TECH INTELLECTUAL PROPERTIES, INC., Blacksburg, VA (US)

(72) Inventors: Joseph R. KUBALAK, Blacksburg, VA (US); Christopher B. WILLIAMS, Blacksburg, VA (US)

(21) Appl. No.: 17/925,436

(22) PCT Filed: May 27, 2021
(86) PCT No.: PCT/US2021/034433

§ 371 Date: Nov. 15, 2022

Related U.S. Application Data
(60) Provisional application No. 63/030,542, filed on May 27, 2020.

(51) Int. Cl. B29C 64/393; B29C 64/236

(52) U.S. Cl. CPC B29C 64/393; B29C 64/236; B33Y 10/00

(57) ABSTRACT

Disclosed are examples for optimizing topology and toolpath creation for multi-axis additive manufacturing. In some examples, layer-less multi-axis ME is achieved by propagating a support structure, propagating deposition paths aligned to arbitrary directions and following an orientation field for the given geometry, and explicitly ordering deposition paths to avoid collisions. In other examples, layer-less multi-axis ME is achieved by aligning extrudate in a three-dimensional space with the orientation field output by a topology optimization algorithm, planning a suitable support structure to enable multi-axis fabrication, and ordering the resulting deposition paths for collision-free fabrication. The created toolpaths can be transmitted to a multi-axis printer for printing.

### CROSS-REFERENCE TO RELATED APPLICATION

This application claims the benefit of and priority to U.S. Provisional Patent Application No. 63/030,542 filed on 27 May 2020, entitled “WORKFLOW FOR LAYER-LESS MULTI-AXIS MATERIAL EXTRUSION,” the contents of which are incorporated by reference in their entirety herein.

### BACKGROUND

XY-planar material extrusion (ME) is supported by robust toolpath planning algorithms that are capable of generating printable toolpaths from any input geometry, but deposition paths can only be planned within the XY-plane. Although multi-axis ME has the flexibility to deposit material along any desired direction (e.g., outside of the XY-plane), current toolpath planning literature is restricted to either i) planar deposition (with a non-XY-plane) or ii) deposition of surface-constrained geometries. These restrictions allow multi-axis ME to leverage toolpath planning techniques from XY-planar ME, but they do not enable deposition in arbitrary directions for arbitrary geometries. Specifically, existing multi-axis toolpath planning strategies are unable to plan toolpaths for inputs where the desired deposition directions do not lie on stratified surfaces. One workflow described in this disclosure addresses this limitation by generalizing ME toolpath planning for layer-less, multi-axis deposition. In addition, due to the generalization, the contained workflow is also suitable for layer-based and surface-constrained deposition.

In addition, the layer-by-layer deposition process used in material extrusion (ME) additive manufacturing results in inter- and intra-layer bonds that reduce the mechanical performance of printed parts. Multi-axis (MA) ME techniques have shown potential for mitigating this issue by enabling tailored deposition directions based on loading conditions in three dimensions (3D). Planning deposition paths leveraging this capability remains a challenge, as an intelligent method for assigning these directions does not exist. Existing literature has introduced topology optimization (TO) methods that assign material orientations to discrete regions of a part by simultaneously optimizing material distribution and orientation. These methods are insufficient for MA-ME, as the process offers additional freedom in varying material orientation that is not accounted for in the orientation parameterizations used in those methods. Additionally, optimizing orientation design spaces is challenging due to their non-convexity, and this issue is amplified with increased flexibility; the chosen orientation parameterization heavily impacts the algorithm's performance. Therefore, another workflow of the present disclosure presents a TO method to simultaneously optimize material distribution and orientation with considerations for 3D material orientation variation and (ii) establish a suitable parameterization of the orientation design space. This workflow of the present disclosure provides a path toward integrating optimized geometries and material orientation fields resulting from the presented algorithm with MA-ME processes.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C illustrate a two-dimensional (2D) example of an orientation field for a voxel-based truss structure. FIG. 1A illustrates an example of a structure with an applied tensile loading case,

FIG. 1B illustrates the load paths corresponding to the load case, and FIG. 1C illustrates an orientation field that describes the directions of the load paths.

FIGS. 2A-2B illustrate examples of XY-planar fabrication process and multi-axis ME, in accordance with various embodiments of the present disclosure.

FIGS. 3A-3C illustrate a two-dimensional (2D) example of an orientation field for a voxel-based truss structure and the XY-planar fabrication process, according to various examples of the present disclosure. In particular, FIG. 3A illustrates alternative examples of a structure with an applied tensile loading case, the load paths for the structure corresponding to the load case, and the orientation field that describes the directions of the load paths within the structure. FIG. 3B illustrates traditional XY-planar deposition that does not result in good alignment with the load paths of FIG. 3A. FIG. 3C illustrates and example of a XY-planar fabrication process and multi-axis ME which enables strong alignment of the load paths of FIGS. 3A, according to various examples.

FIGS. 4A-4C illustrate a two-dimensional (2D) example of an orientation field for a voxel-based truss structure and the XY-planar fabrication process, according to various examples of the present disclosure. In particular, FIG. 4A illustrates alternative examples of a structure with an applied tensile loading case, the load paths for the structure corresponding to the load case, and the orientation field that describes the directions of the load paths within the structure. FIG. 4B illustrates traditional XY-planar deposition that does not result in good alignment with the load paths of FIG. 4A. FIG. 4C illustrates and example of a XY-planar fabrication process and multi-axis ME which enables strong alignment of the load paths of FIGS. 4A, according to various examples.

FIGS. 5A and 5B illustrate examples of the layer-less multi-axis toolpath planning workflow according to various embodiments of the present disclosure.

FIGS. 6A and 6B illustrate 2D examples of propagated support material, in accordance with various embodiments of the present disclosure.

FIGS. 7A-7C illustrates a planar example of the support propagation algorithm, in accordance with various embodiments of the present disclosure.

FIG. 8 illustrates an example of a streamline placement process, in accordance with various embodiments of the present disclosure.

FIG. 9 illustrates an example of an advection process used to propagate streamlines, in accordance with various embodiments of the present disclosure.

FIG. 10 illustrates an example of a deposition head depositing road i at an orientation specified by the build direction of road i, in accordance with various embodiments of the present disclosure.

FIG. 11 illustrates an example of a high-level overview of the ordering algorithm used to create a collision-free toolpath, in accordance with various embodiments of the present disclosure.

FIG. 12 illustrates an example of a six degree of freedom (DoF) ME system used to fabricate the example geometry and orientation field, in accordance with various embodiments of the present disclosure.

FIGS. 13A-13B illustrate photographs of a fabricated quarter Wheel geometry, in accordance with various embodiments of the present disclosure.

FIGS. 14A and 14B illustrate the load cases used to optimize a planar geometry, in accordance with various embodiments of the present disclosure.

FIG. 15 illustrates an extension to the deposition path planning algorithm in FIG. 8 and FIG. 9, in accordance with various embodiments of the present disclosure.

FIG. 16 illustrates an example fabricated planar optimized geometry, in accordance with various embodiments of the present disclosure.

FIG. 17 illustrates the load cases used to optimize a planar geometry, in accordance with various embodiments of the present disclosure.

FIG. 18 illustrates the load cases used to optimize a planar geometry, in accordance with various embodiments of the present disclosure.

FIG. 19 illustrates the load cases used to optimize a planar geometry, in accordance with various embodiments of the present disclosure. In particular, FIG. 19 illustrates a pure-tension load case and a three-point bend load case. The shaded areas represent fixed-density regions which are only optimized for orientation.

FIG. 20 illustrates an example output of a topology optimization algorithm illustrating both overhead and isometric viewpoints. The output includes the associated density, material deposition, deposition direction, intra-layer bond direction, and inter-layer bond direction, in accordance to various embodiments of the present disclosure.

FIG. 21 illustrates a chart illustrating a final objective function value comparison between the different orientation parameterizations for the MBB beam problem, in accordance to various embodiments of the present disclosure.

FIG. 22 illustrates a chart illustrating a convergence history of the first three continuation cycles, in accordance to various embodiments of the present disclosure.

FIG. 23 illustrates a chart illustrating a final objective function value comparison between the different orientation parameterizations for the wheel problem, in accordance to various embodiments of the present disclosure.

FIG. 24 illustrates a chart illustrating a convergence history of the first three continuation cycles for the wheel problem, in accordance to various embodiments of the present disclosure.

FIG. 25 illustrates an example plot of the final compliance values of the wheel problems for each orientation parameterization, in accordance to various embodiments of the present disclosure.

FIG. 26 illustrates an example plot of the final compliance values of multi-load case for each orientation parameterization, in accordance to various embodiments of the present disclosure.

### DETAILED DESCRIPTION

Disclosed herein are various embodiments related to workflows for optimizing topology and toolpath creation for multi-axis additive manufacturing and enabling layer-less multi-axis material extrusion (ME). In some examples, the workflow includes algorithms for i) propagating support structure, ii) propagating deposition paths aligned to arbitrary directions, and iii) explicitly ordering deposition paths to avoid collisions. A modular structure is used for the workflow to allow for the exchanging, improvement, or exclusion of discrete algorithms as required by the part being printed without necessitating changes to the other portions of the workflow. The outcome of the presented methodology is a toolpath with deposition paths that follow an orientation field, which represents the desired deposition directions throughout the structure. The modular based workflow is validated through demonstration using a topology optimized (TO) Wheel geometry and a TO planar geometry featuring multiple loading conditions, and the produced toolpath is fabricated on a 6 degree of freedom (DoF) ME system. In other embodiments, working at the nexus of multi-axis robotics, additive manufacturing (AM) technologies, and topology optimization, the present disclosure relates to a multi-axis AM design workflow that enables concurrent optimization of part topology and printing toolpath such that the anisotropy of the deposited material is preferentially and specifically aligned within the printed structure to maximize part performance.

### Workflow for Optimizing Topology and Toolpath for Multi-Axis Additive Manufacturing

While additive manufacturing (AM) is often referred to as “3D printing,” the technologies typically only deposit material in 2D planes on a layer-by-layer basis. These repetitive, stacked layer interfaces result in a part with anisotropic properties wherein weakness is aligned with the build direction. This is especially true of components made with material extrusion (e.g., fused filament fabrication, FFF) AM processes, in which poor inter-layer and intra-layer (i.e., between adjacent depositions) bonding results in mechanical properties that are much weaker than those found in their traditionally manufactured counterparts. However, the inherent anisotropy of extruded fiber-reinforced materials (e.g., short fiber-reinforced polymers and continuous fiber-reinforced coextrusions) presents an opportunity to offer a transformative step-change in the properties of AM parts. Specifically, by working at the nexus of multi-axis robotics, AM technologies, and topology optimization, the various embodiments of the present disclosure relate to a multi-axis AM design workflow that enables concurrent optimization of part topology and printing toolpath such that the anisotropy of the deposited material is preferentially and specifically aligned within the printed structure to maximize part performance. This workflow enables a reinforced (e.g., carbon fiber-loaded) thermoplastic to be deposited such that it is aligned to a topology-optimized part's anticipated three-dimensional (3D) load paths (which collectively form an “orientation field”). As such, the present disclosure enables a new engineering paradigm in which AM moves away from layered 2D printing and towards leveraging the inherent anisotropy of the deposited material in a true 3D deposition process to maximize part performance.

The goal of disclosed workflow is to improve the structural efficiency and mechanical performance of composite structures by simultaneously optimizing for both part topology and printing toolpath for multi-axis AM technologies. The key component of this disclosure is the computational framework for optimizing part topology and multi-axis printing toolpath for any arbitrary geometry and any 3D orientation field. While this framework allows for concurrent optimization of structure and any performance objective (e.g., heat transfer, vibration mitigation, etc.), the primary validation focus is on mechanical performance.

Existing topology optimization (TO) approaches are insufficient for the workflow as they generally only consider density distribution (i.e., the shape of the part); manufacturing considerations are separated from the generative design process, which requires post-processing of the results to ensure manufacturability, leading to a degradation of optimality and a reduction of structural efficiency. While some TO methods incorporate manufacturability of the designed shape during the analysis (e.g., by imposing minimum feature size and overhang constraints, they do not include considerations for the toolpath used to fabricate the structure. The workflow of the present disclosure avoids such performance compromises through a TO approach that can determine both material distribution and orientation in 3D space and also includes explicit considerations for the multi-axis AM process (e.g., tool head collisions and local density changes due to orientation field variation).

Multi-axis AM has been demonstrated in literature, but the focus has typically been on reducing support structure or conformally printing on nonplanar substrates. Known workflows have demonstrated mechanical property improvements using multi-axis AM, but their toolpath planning capabilities heavily limit the classes of geometries and associated orientation fields that can be fabricated. To properly leverage the full geometric flexibility of AM technologies, the workflow of the present disclosure determines multi-axis robotic toolpaths that i) aligns extrudate in 3D space with the orientation field output by the TO algorithm, ii) plans suitable support structure to enable multi-axis fabrication, and iii) orders the resulting deposition paths for collision-free fabrication.

AM of composite materials is an emerging manufacturing and research area in industries that require competing strength and weight metrics (e.g., aerospace, automotive, prosthetics, athletic equipment). While conventional AM technologies have the desired geometric flexibility, the inherent process anisotropy does not allow printed parts to achieve the necessary strength specifications. Through the convergence of multi-axis robotics, AM technologies, and TO, the present disclosure leverages material anisotropy to improve overall part performance by aligning material strength with anticipated load paths via true 3D fabrication. Although the present disclosure relates to improving the stiffness and weight of printed components, the orientation field representation of the desired material orientations gives the workflow additional flexibility; other metrics (e.g., thermal conductance/dissipation, fluid/material flow, electrical conductance, mode shapes, natural frequencies, stiffness, stress, (e.g., von Mises), etc.) could be used to define the orientation field and non-mechanical anisotropy (e.g., conductivity) could be preferentially aligned with that orientation field. By combining objective functions, it should even be possible to simultaneously optimize for multiple metrics.

Deposition Alignment Through Layer-Less Multi-Axis ME

The ME additive manufacturing (AM) process typically features the layer-by-layer deposition of a heated thermoplastic onto a substrate. The material cools rapidly after deposition, resulting in poor bonding between the discrete layers and between adjacent deposition paths (roads) within each layer. These poor bonds result in a part with an overall anisotropic mechanical performance, where the part is strongest along the direction of material deposition. Therefore, design for AM guidelines recommend orienting the part such that load is not applied to the inter- or intra-layer bonds. For parts with simple loading conditions (e.g., a tensile bar), it may be possible to find an orientation that satisfies this guideline, but for multi-axial or otherwise complex loading conditions, such an orientation is often unavailable. In order to accommodate these complex loading conditions, more flexibility is required of the deposition strategy.

High DoF systems enable the reorientation of the deposition head and part relative to each other. This additional flexibility enables material deposition along any arbitrary vector (e.g., vectors that do not lie on the XY-plane), allowing the reinforcement of the part in any direction. Therefore, parts fabricated via high-DoF (multi-axis) ME can be deposited such that each deposition is highly aligned to the anticipated load paths within the structure, even if the load paths are non-planar. As a result, high-DoF deposition has the capacity to produce parts with improved mechanical performance compared to XY-planar deposition.

While XY-planar ME is supported by a number of robust toolpath planning algorithms that allow any arbitrary geometric input, multi-axis ME introduces a number of challenges not addressed in XY-planar ME including: i) propagating suitable support structure, ii) planning non-planar roads, and iii) explicitly ordering the roads in a collision-free manner.

Due to the complexity of these issues, existing multi-axis toolpath planning methods make assumptions in efforts to simplify the toolpath planning problem. These assumptions limit both the geometries that can be processed and the deposition directions that can be used.

Existing Multi-Axis Toolpath Planning

The reorientation capabilities of multi-axis ME systems enable the use of multiple build directions throughout a single part. By using multiple build directions, the toolpath used to create the part can be highly tailored to the manufacturing requirements of the part. For instance, build directions can be selected to minimize (and often completely remove) the support structure underneath overhanging features. These methods are often embodied by decomposing the overall part geometry into distinct regions, each assigned a unique build direction. Each distinct region can then be sliced individually using slicing software similar to those used in 3-DoF XY-planar ME. These planar multi-axis ME algorithms have also been developed for printing partitioned geometries onto cuboid inserts and improving surface finish. Planar multi-axis methods benefit from being able to leverage existing slicing software to plan roads and partially mitigate the issue of collisions by depositing discrete layers (although collisions can still exist depending on the geometry and selected build directions).

Improving mechanical properties is difficult with planar multi-axis ME due to poor bonding at the interfaces between regions with different build directions. Specifically, these inter-region bonds have been demonstrated to have worse performance than the inter-layer bonds in XY-planar prints. Therefore, planar multi-axis ME suffers from the same shortcoming as XY-planar ME; unless the geometry's anticipated load paths travel along stratified planar layers, it is not possible to remove either the inter-layer or inter-region bonds from the load paths.

Non-planar (i.e., curved layer) multi-axis ME provides additional flexibility in the customization of mechanical properties. This benefit has been previously demonstrated with a 5-DoF system used to fabricate hemispherical pressure caps with stress-aligned roads. These stress-aligned specimens ruptured at pressures 4.5 times greater than specimens fabricated through XY-planar ME. TO 2.5D surface geometries using a 6-DoF robotic arm have been fabricated, which demonstrated increased maximum compressive load when compared to geometrically similar XY-planar parts. Previous work has demonstrated the improvement of tensile specimens through the multi-axis ME of conformal surface reinforcement using a 6-DoF robotic arm. The yield tensile strength of the multi-axis reinforced specimens was 59% greater than unreinforced XY-planar specimens.

In each case, the anticipated load paths experienced by the structure developed stratified surfaces. Each curved surface could be deposited independently to prevent collisions between the deposition head and printed part. If the load paths did not follow stratified surfaces though, these non-planar multi-axis methods would be unable to plan roads completely aligned to the load, resulting in suboptimal material orientation.

Handling load paths that do not follow stratified layers (referred to as volumetric load paths) requires layer-less deposition, which does not leverage layer-like structures to simplify the toolpath planning problem. While this style of deposition imparts a large amount of flexibility to the process, the road propagation problem becomes much more complex. Additionally, collisions between the deposition system and previously deposited material must be handled carefully in the process planning stage to enable successful fabrication.

Currently, layer-less multi-axis (LL-MA) ME is limited to the fabrication of wireframe structures. While demonstrative of LL-MA ME, wireframe structures do not allow for the alignment of roads with volumetric load paths. Therefore, a gap has been identified in the scope of a workflow for processing an arbitrary geometry with volumetric load paths into a manufacturable LL-MA toolpath.

Orientation Fields

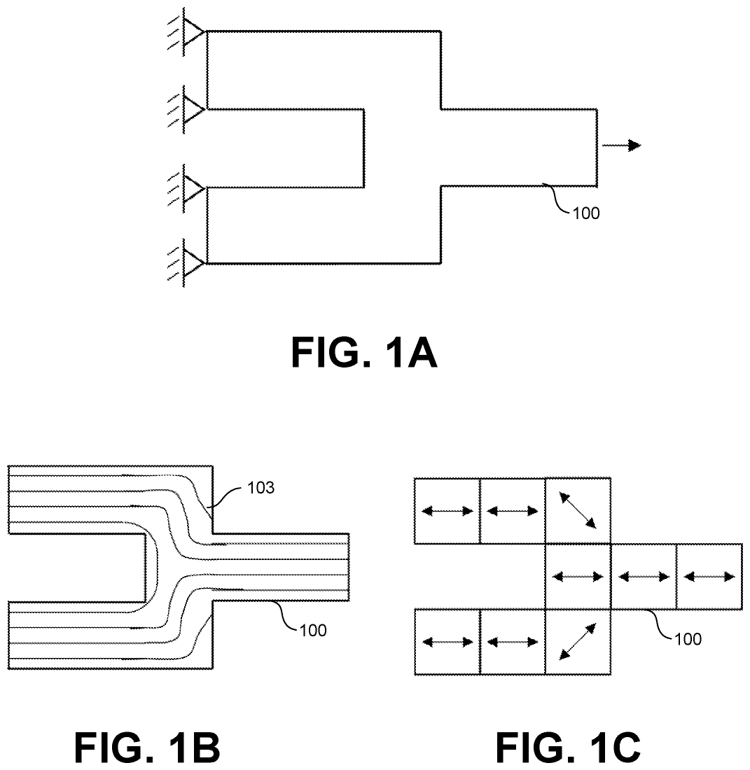

While the present disclosure focuses on aligning deposition directions to load paths for the purpose of improving mechanical properties, it may be desirable to align the deposition direction according to any number (or combination) of criteria (e.g., (e.g., thermal conductance/dissipation, fluid/material flow, electrical conductance, mode shapes, natural frequencies, stiffness, stress, (e.g., von Mises), etc.). As a whole, the directions determined by the selected criteria describe the direction of material deposition at each point in the geometry. For the purpose of generality, the set of desired deposition directions throughout the part will be referred to as an orientation field. A two-dimensional (2D) example of an orientation field for a voxel-based truss structure is shown in FIGS. 1A-1C. In particular, FIG. 1A illustrates an example of a structure 100 with an applied tensile loading case, FIG. 1B illustrates the load paths 103 for the structure 100 corresponding to the load case, and FIG. 1C illustrates an orientation field that describes the directions of the load paths 103 within the structure 100.

Although the orientation fields presented in this disclosure are generated through a TO algorithm that assigns material orientations as well as densities to each voxel in the design space (algorithm is presented in J. R. Kubalak, A. L. Wicks, and C. B. Williams, “Topology Optimization to Enable Multi-Axis Material Extrusion Additive Manufacturing,” Journal of Mechanical Design (accepted) (hereinafter referred to as “Kubalak”) which is incorporated by reference herein in its entirety, the orientation field could be generated by other means and still be valid input to the presented workflow. For instance, finite element analyses (FEA) could be used to determine von Mises stresses throughout the structure; these stresses could be used to populate the orientation field (e.g., the first principal stress corresponds to the deposition direction). As another example, if the user has some intuition, prior knowledge, or is concerned about a region of the part, they could manually change or assign the material orientations to their own specifications. Any orientation field, whether manually or computationally generated can be processed with the workflow presented in this disclosure.

The bi-directional vector denoted in each voxel of FIG. 1B roughly corresponds to the load path directions within each voxel. The example orientation field shown in FIG. 1C illustrates the desired deposition directions within each voxel of the geometry. While this is enough information to define a toolpath for XY-planar deposition (where the deposition head only has a single possible orientation), the deposition head can take any orientation in multi-axis deposition; the build direction (e.g., the vector that the deposition head aligns to) for each deposition path must also be assigned during toolpath planning.

Generalized Multi-Axis Workflow

Multi-axis ME enables the opportunity to highly tailor the toolpath (e.g., the deposition and build directions) used to fabricate the part for a specific end-use application. Existing multi-axis path planners, though, are insufficient for planning manufacturable toolpaths for volumetric orientation fields (e.g., an orientation field formed by volumetric load paths). According to various embodiments, the present disclosure relates to a workflow for planning such toolpaths for arbitrary geometries and orientation fields. Specifically, the presented LL-MA workflow generalizes the XY-planar toolpath planning processes for volumetric roads and toolpaths.

Challenges with Multi-Axis Deposition

There are a number of challenges associated with generalizing the typical XY-planar toolpath planning algorithm for LL-MA ME. Highlighted below, each outlined challenge is discussed in more detail in the following subsections.

Geometric Representation. Typical XY-planar toolpath planning algorithms utilize surface-based representations (e.g., the STL file) of the desired geometry. These geometric representations do not contain information regarding the interior of the part, preventing the integration of an orientation field, which is required to describe the desired deposition directions within the part.

Support Structure. Support structure serves two purposes: i) provide a substrate for deposition and ii) support the recently deposited features during cooling. In XY-planar ME, support structure propagated along the global Z-axis simultaneously accomplishes both of these tasks. In multi-axis ME, support structure propagated in this manner does not necessarily provide a substrate for deposition due to the use of variable build directions.

Road Propagation. Roads in XY-planar ME are propagated layer-by-layer between the extracted contours of the input geometry. In LL-MA ME, roads are not constrained and require novel planning methods to ensure the resulting roads follow the orientation field associated with the geometry.

Toolpath Ordering. The roads in an XY-planar toolpath are ordered in terms of ascending Z-height to preserve the layer-by-layer structure. This inherently prevents collisions between the deposition head and previously deposited material, because at any point in the toolpath, all remaining roads will be above the previously deposited material. Without layer-like structures (e.g., surfaces), a novel ordering algorithm is required to prevent collisions in a LL-MA toolpath.

### Geometric Representation

The de facto geometric representation for AM technologies is the stereolithography (STL) file, which represents the surface of a geometry using a triangle tessellation. While commonplace, the STL file is frequently reported to have deficiencies in terms of incorporating information regarding the fabrication of the part. Critically, surface-based representations are incapable of directly associating an orientation field with the geometry. Therefore, a different geometric representation is required to enable LL-MA fabrication. A number of file formats have been suggested to replace the STL file, but voxel-based formats are of particular interest for applications in LL-MA ME. Voxels are uniquely defined throughout the geometry, which enables the integration of other useful information for manufacturing including material type and material properties. Therefore, the orientation field required for denoting deposition directions could be directly integrated into the voxel representation of the geometry. With this in mind, the workflow presented in the present disclosure requires that a voxel-based representation of the desired geometry can be created with an associated orientation field.

Although voxel-based geometries are a convenient geometric representation for the workflow presented in this disclosure, having a geometry in this form is not a requirement for functionality. Translating geometries to voxel-based structures is easily performed with other geometric representations (e.g., STL files, AMF files, STEP files, etc.). Similarly, orientation fields defined using non-voxel based meshes (e.g., isoparametric elements common in FEA) can be converted to voxel-based meshes.

### Support Structure

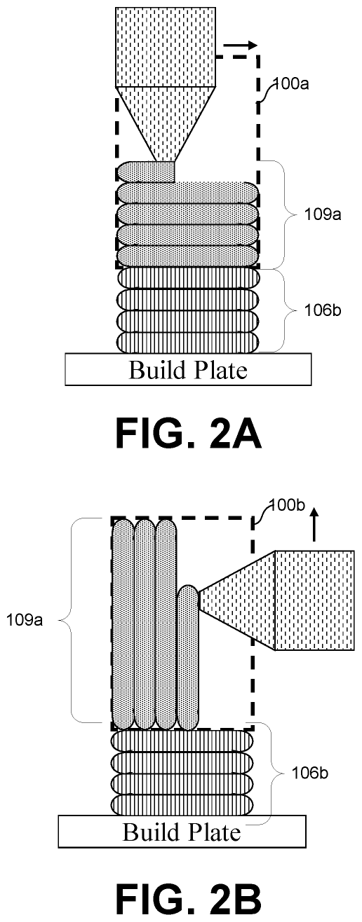

Multi-axis ME utilizes multiple build directions throughout a single part in order to place roads with increased flexibility. Many multi-axis algorithms select these build directions specifically to minimize (or eliminate) the support structure required during fabrication. If the build directions are chosen using a specified orientation field though, it may be necessary to have dedicated support structure to enable successful fabrication. FIGS. 2A and 2B illustrate examples of XY-planar fabrication process and multi-axis ME. In particular, FIG. 2A illustrates an example XY-planar fabrication process. In FIG. 2A, the deposition head is aligned to the build direction and prints the structure 100 (e.g., 100a, 100b) layer-by-layer. Support structure 106 (e.g., 106a, 106b) provides a substrate for deposition and supports the deposited model material 109 (e.g., 109a, 109b) during cooling. FIG. 2B illustrates an example of multi-axis ME. This style of propagation does not necessarily result in a substrate for deposition.

Support structure 106 in XY-planar ME is propagated along the global Z-axis (e.g., the build direction), as shown in FIG. 2A, to support overhanging features by providing i) a substrate for deposition and ii) support during the cooling process to preserve feature positioning. In the context of multi-axis ME, this method of support propagation does not necessarily generate structures that satisfy both criteria. As shown in FIG. 2B, the support structure 106b propagated along the global Z-axis does not provide a substrate for deposition. Therefore, some more intelligent method of propagating support structure along multiple build directions is required.

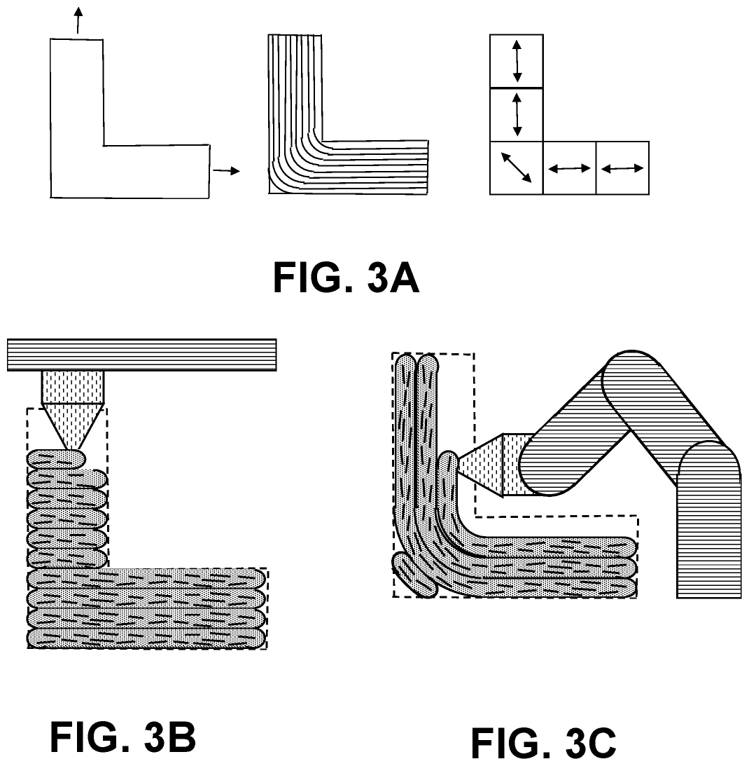

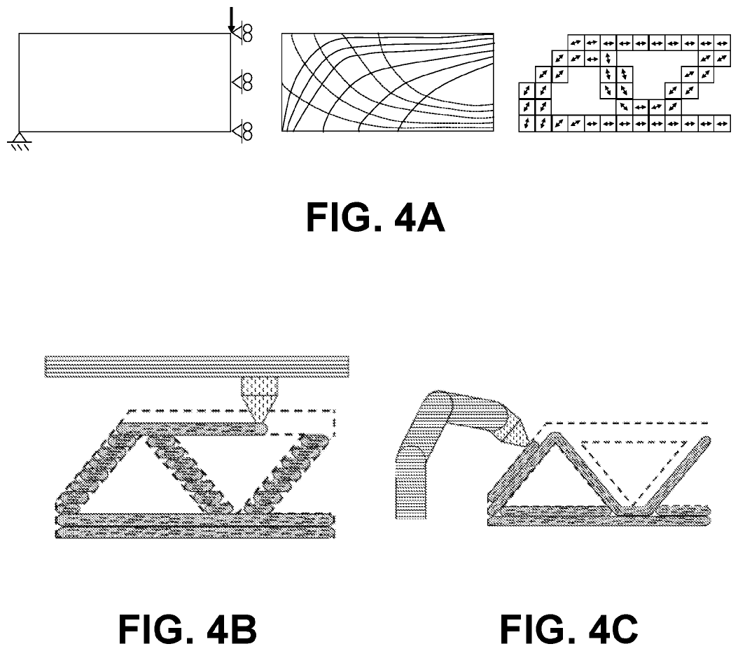

FIGS. 3A-3C and 4A-4C illustrate alternative examples to those of FIGS. 1A-2B. In particular, FIGS. 3A and 4A illustrate alternative examples a structure 100 with an applied tensile loading case, the load paths 103 for the structure 100 corresponding to the load case, and the orientation field that describes the directions of the load paths 103 within the structure 100. In particular, FIGS. 3B and 4B illustrate traditional XY-planar deposition that does not result in good alignment with the load paths of FIGS. 3A and 4A, respectively. FIGS. 3C and 4C alternative illustrate examples of XY-planar fabrication process and multi-axis ME which enables strong alignment of the load paths of FIGS. 3A and 4A, respectively.

Road Propagation

Propagating roads through a volumetric orientation field requires connecting discrete voxels, each with unique orientations as shown in FIG. 1C, with continuous roads. Roads could be propagated through each voxel individually, but the interfaces between voxels are then subject to the same thermal characteristics as the inter-layer bonds in XY-planar ME. This would produce a print with poor mechanical performance, similar to the inter-region bonds in planar multi-axis ME. A solution for propagating continuous roads in a planar orientation field (i.e., all desired deposition directions lie within the XY-plane) that follows the contours of the geometry has been previously presented in prior studies. Using this method, a traditional infill is neglected in favor of a toolpath consisting of exclusively contours paths (i.e., deposition paths on or offset from the perimeter of each layer). There are two main shortcomings with this method: i) it requires assumptions regarding the shape of the orientation field relative to the geometry and ii) it does not scale up to 3D as it relies on extracting the roads directly from the layers of the geometry. In 3D, the extracted contours would be surfaces, rather than lines, and would require additional processing to produce roads.

Instead, a volumetric approach to creating roads is preferred. A method for volumetrically generating roads using a series of isosurfaces propagated through the geometry has been presented. Although the ability to propagate a 3D structure with a predefined path shape was demonstrated through this method, the ability to follow an orientation field was not addressed.

A modified streamline placement algorithm, leveraged from fluid flow visualization literature, was used to fill a geometry with roads that follow an orientation field. That method used vector integration to develop each road, ensuring that the resulting path accurately follows the input orientation field. The result is a series of volume-filling, continuous roads that connect the discrete voxels without requiring assumptions regarding the shape of the geometry relative to the orientation field. Although the roads were volumetrically generated, that work was limited to XY-planar orientation fields and did not explore volumetric orientation fields. That said, streamline placement algorithms (on which the technique was based) have been used for 3D velocity fields. Therefore, the workflow presented in the present disclosure generalizes that road propagation algorithm for LL-MA geometries and orientation fields.

Toolpath Ordering

In typical XY-planar ME, layers are printed sequentially in terms of ascending Z-height. This prevents the deposition head from colliding with previously deposited material, as it guarantees that no material will ever be above the deposition head. In LL-MA ME however, roads cannot be ordered in this manner, as they often change Z-heights along their length. This Z-height variation combined with non-uniform build directions throughout the part does not allow LL-MA ME to make this assumption; an improperly planned toolpath could introduce collision concerns where previously deposited material prevents the deposition head from accessing undeposited regions of the part. Therefore, a more intelligent ordering algorithm is required for LL-MA ME.

Rather than making an assumption that relies on the structure of the print (e.g., sequential layer stacking), a LL-MA ordering algorithm must take into account the build direction and deposition head footprint required by each road. This consideration is similar to the issue of tool head access experienced in assembly problems with traditional manufacturing. In both cases, the tool must have access to a certain region in order to perform a given task. The assembly problem looks at a set of tasks and orders them such that the tool head has access to the required region at every point in the process.

However, one consideration not accommodated in typical assembly problems is the desire to perform certain tasks in a sequential order, such as depositing certain roads continuously. Specifically, in order to improve the final mechanical performance of the printed structure, it is desirable to print roads that share an end point one after the other in order to maintain continuity. If this continuity is not maintained, the shared end point would require bonding similar to the inter- and intra-layer bonds in typical XY-planar ME, resulting in a reduction in mechanical performance. A LL-MA toolpath ordering algorithm must therefore order connected roads in sequential order to preserve mechanical performance.

Assembly Ordering Algorithms

By considering each road comprising the desired structure as an individual task to be completed, the ordering problem can be explored as an assembly problem similar to those found in traditional manufacturing. In this type of problem, it is well known that an exhaustive combinatorial search is infeasible due to the number of tasks. Instead, these problems are explored in terms of the interactions between each component or task in the assembly to inform a final assembly plan. These algorithms are often only demonstrated for assemblies with a small number of components (typically under 100), making them infeasible for printing applications, which often consist of more than 10,000 roads.

For large assembly problems, it is often easier to plan the disassembly of the structure, rather than the assembly. This is due to the fact that the assembled structure is more heavily constrained than the unassembled components, which reduces the number of feasible options. A number of reviews have been written on the topic of disassembly, primarily focused on disassembly for recycling, using similar algorithms to those discussed for assembly planning. Critically, a valid disassembly plan can be inverted to create a valid assembly plan if the disassembly is non-destructive and does not involve deformable components (often referred to as assembly-by-disassembly).

Using the classification framework presented by H. Srinivasan, N. Shyamsundar, and R. Gadh, “A framework for virtual disassembly analysis,” Journal of Intelligent Manufacturing, vol. 8, no. 4, pp. 277-295, 1997, which is incorporated by reference herein in its entirety, the disassembly problem relevant to LL-MA ME can be defined to assist in identifying an appropriate solution. By the definitions presented in that work, the problem of LL-MA toolpath planning is 1-disassemblable, as only a single linear deposition head movement is required for any given road. The problem is also monotonic and sequential, as only a single road can be created (or removed) at a time. Finally, the toolpath requires a complete disassembly plan (e.g., all roads must be disassembled individually) and the disassembly plan must be non-destructive. Due to the relative simplicity of this problem, only a precedence matrix (e.g., a matrix describing the order in which tasks can be completed) is required to develop a feasible toolpath. Although, in order to maintain continuity between roads that share an end point, a continuity matrix (i.e., a matrix describing roads that form continuous depositions) should also be considered.

Multi-Axis Toolpath Planning Workflow

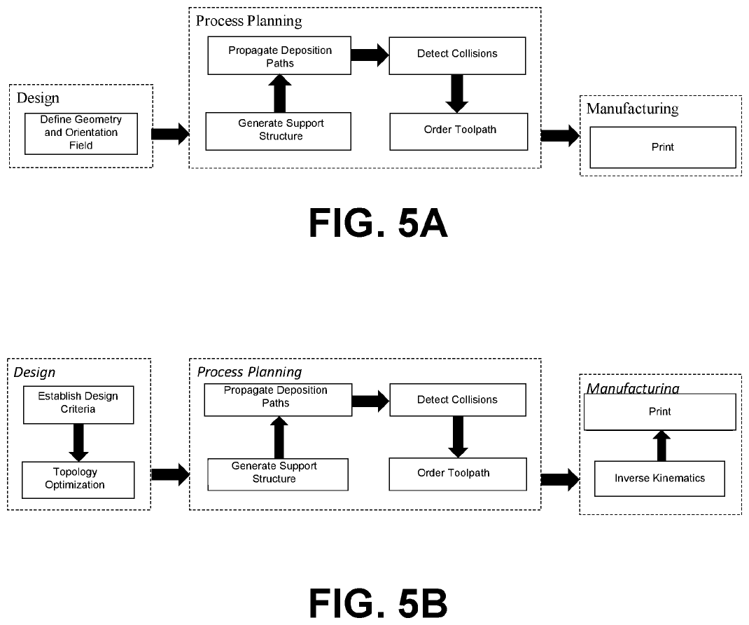

The typical XY-planar ME workflow is insufficient to plan toolpaths for LL-MA ME. This more flexible style of printing introduces a number of challenges that must be addressed in order to process geometries with volumetric orientation fields in a generalized, robust fashion. Accordingly, the present disclosure relates to a LL-MA toolpath planning workflow, which takes a voxel-based geometry with an associated orientation field as input. Each module of the workflow is discussed in the following subsections. FIGS. 5A and 5B illustrate example flowcharts 500 (e.g., 500a, 500b) illustrating the LL-MA toolpath planning workflow according to various embodiments of the present disclosure. In particular, FIGS. 5A-5B illustrate workflows for processing arbitrary geometries and orientation fields for LL-MA ME. IN FIG. 5A, a geometry and corresponding orientation field is supplied by the user. This is then i) propagated for LL-MA suitable support structure, ii) roads are propagated through both the model and support geometries, and iii) the resulting roads are ordered in a collision-free manner. An ordered toolpath can then be sent to the multi-axis printer for fabrication.

The workflow of FIG. 5B is an alternative to the workflow of FIG. 5A. In particular, in the workflow of FIG. 5B corresponds to a topology and toolpath optimization (TTO) workflow that integrates manufacturing constraints (e.g. collision concerns) and toolpath planning considerations (e.g., local density reduction due to deposition packing) into the design phase, where structural design decisions can be made to accommodate them, preserving design optimality. In various examples, the design criteria (e.g., (e.g., thermal conductance/dissipation, fluid/material flow, electrical conductance, mode shapes, natural frequencies, stiffness, stress, (e.g., von Mises), etc.). associated with the structure 100 is established and topology is optimized and orientation fields are generated based on the criteria, manufacturing constraints, and toolpath considerations. The optimized topology and generated orientation fields are then then i) propagated for LL-MA suitable support structure, ii) roads are propagated through both the model and support geometries, and iii) the resulting roads are ordered in a collision-free manner During the manufacturing process, and prior to printing, inverse kinematics (IK) may be solved for the road using the assigned build direction. The resulting joint angles place the deposition platform in the environment as they would be during fabrication of a road (i). Therefore, at each joint angle, collisions should be calculated between the deposition platform and all roads (j). The ordered toolpath is then be sent to the multi-axis printer for fabrication.

### Support Generation

The LL-MA support generation algorithm (Algorithm 1) generalizes the concept of projecting a geometry into the deposition plane for arbitrary build directions.

Algorithm 1: Multi-axis support generation algorithm

| | Input: B, R, T | | | | | |
|---|---|---|---|---|---|---|
| | Output: B′, R′, T′ | | | | | |
| 1 | B: Vector of build directions for the voxels | | | | | |
| 2 | R: Vector of road directions for the voxels | | | | | |
| 3 | T: Vector denoting voxel type (0 = void, −1 = support, 1 = model) | | | | | |
| 4 | n = number of voxels | | | | | |
| 5 | B′ = B = [bᵢ] | | | | | |
| 6 | R′ = R = [rᵢ] | | | | | |
| 7 | T′ = T = [tᵢ] | | | | | |
| 8 | O = \|oᵢ\| where oᵢ = (tᵢ == 1) ∀ l = 1, . . . , n | | | | | |
| 9 | A = \|aᵢ\| where aᵢ = ∅ ∀ i = 1, . . . , n | | | | | |
| 10 | while [symbol] (O) do | | | | | |
| 11 | \| | for ( i = 1, i <= n; i = i + 1 ) | | | | |
| 12 | \| | \| | if oᵢ then | | | |
| 13 | \| | \| | \| | for ( j = 1, j < = 8; j = j + 1 ) | | |
| 14 | \| | \| | \| | \| | Project node j of voxel i along [symbol] | |
| 15 | \| | \| | \| | \| | v = number of the first contracted voxel | |
| 16 | \| | \| | \| | \| | if [symbol] = = 0 then | |
| 17 | \| | \|_ | \|_ | \|_ | \|_ | Append i to aᵢ. |

| 18 | \| | oᵢ = FALSE ∀ l = 1, . . . , n | | |
|---|---|---|---|---|
| 19 | \| | for ( i = 1, i < = n; i = i + 1 ) | | |
| 20 | \| | \| | if vi ≠ 0 then | |
| 21 | \| | \| | \| | Set ∀ᵢ and rᵢ² |
| 22 | \| | \| | \| | [symbol] = −1 |
| 23 | \| | \| | \| | oᵢ = TRUE |
| 24 | \|_ | \|_ | \|_ | oᵢ = ∅ |

[symbol]

indicates data missing or illegible when filed

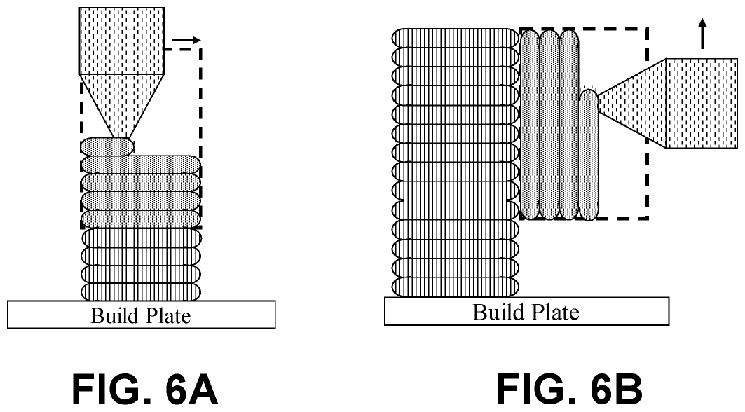

At a high level, the nodes of each model material voxel are projected along the negative of the voxel's build direction to find unsupported regions (i.e., void voxels). Those unsupported regions become support voxels with assigned deposition and build directions. Some of the created support voxels may themselves be unsupported along their build direction, so the process repeats using those recently created support voxels. The process terminates when no additional support voxels were created during the previous iteration. FIGS. 6A and 6B illustrate 2D examples of propagated support material. Additional details on specific subfunctions are given in their corresponding subsections. In particular, in FIG. 6A when the build direction aligns with the global Z-axis, the support material generated with the LL-MA algorithm produces the same support structure used in XY-planar printing, and in FIG. 6B, if the build direction does not align to the global Z-axis, the support structure produced still provides a substrate for the deposition head to print onto.

### Project Node to Find Contacting Voxel

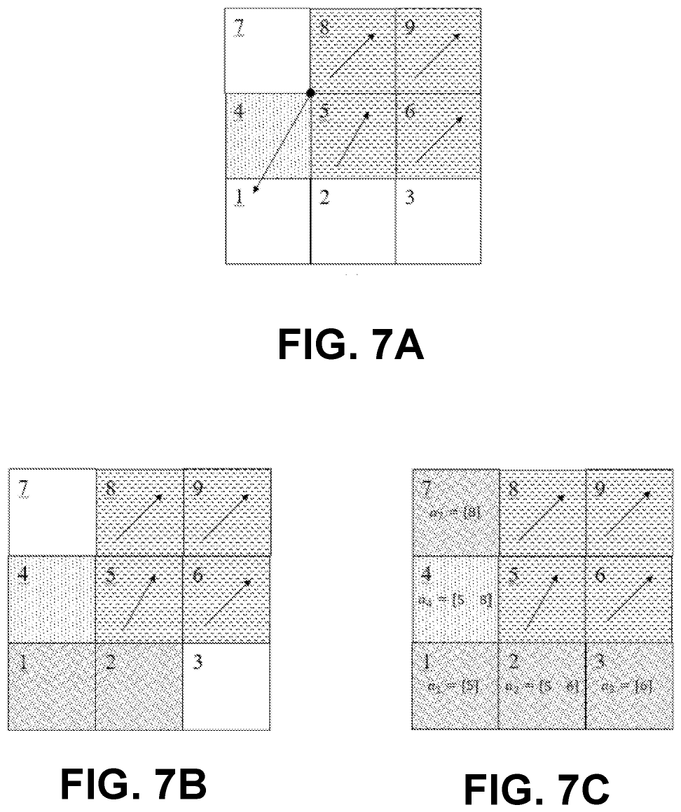

In order to determine the voxels required to support a certain voxel i, each node of the voxel is projected along the negative of the voxel's associated build direction (FIG. 7A). If the first voxel contacted during the projection is a void voxel, voxel i is not sufficiently supported, as there will be no substrate underneath that node during deposition. Therefore, the first contacted voxel (v) must become a support voxel; this is denoted in A by appending i to the vector aᵥ (FIG. 7C). A is then used to assign new build and road directions to the new support voxels. FIGS. 7A-7C illustrate a planar example of the support propagation algorithm. Model voxels are shown in grey, void voxels are shown in white, and support voxels are shown in blue. The build directions of the model voxels are represented by arrows in the center of those voxels. In FIG. 7A, a node is projected along the negative build direction of voxel 5 and first intersects with voxel 4. In FIG. 7B, all of the voxels required to support voxel 5 along its build direction (e.g., voxel 1, voxel 2, voxel 4), are highlighted in blue. FIG. 7C shows the values of the A matrix in Algorithm 1 after projecting all of the model voxel nodes.

### Define Road and Build Directions

After defining the region of voxels that must become support structure (denoted by the non-empty entries in A), the build and road directions of those voxels need to be defined. In order to interface well with the voxels being supported, it is ideal to have the road directions of the support voxels oriented orthogonal to the road directions of the voxels being supported. This allows the roads in the model voxels to contact multiple supporting roads to better maintain the deposition shape and positioning. If, for example, the support roads were parallel to the model roads, the model roads might slip in between support roads and make minimal contact with the support. Taking FIG. 7C as an example, the road direction of voxel 4 should be orthogonal to the road directions of voxels 5 and 8. Although, depending on the road directions of the voxels being supported, it may not be possible to assign a road direction orthogonal to all of them. In this case, an approximate road direction is calculated as the average of the road directions of the supported voxels; this approximate road direction is then used to find the orthogonal direction. This results in a plane of orthogonal directions suitable for the assigned road direction, rather than a singular vector; this plane can be constrained to a single vector by first selecting a build direction. In order to drive the generated support structure to the build platform as quickly as possible, the global Z-axis is assigned as the build direction. Therefore, the assigned road direction is given by Equation 1.

$$\hat{r} = \frac{\tilde{n} \times \hat{z}}{\vert \tilde{n} \times \hat{z} \vert} \qquad ( 1 )$$

\hat{r} is the assigned road direction, \hat{z} is the assigned build direction (e.g., the global Z-axis), and ñ is the approximated road direction of the supported voxels.

### Road Propagation

Roads must be planned through the structure, both aligned to i) the input orientation field provided with the geometry and ii) the orientation field of the support structure developed in the previous module. Existing algorithms for propagating roads aligned with orientation fields are insufficient for LL-MA ME. Prior work in leveraging streamline placement algorithms was restricted to planar orientation fields and geometries, but there are existing streamline placement algorithms that populate 3D velocity fields operating on similar vector integration schemes. Therefore, the algorithm discussed in J. R. Kubalak, A. L. Wicks, and C. B. Williams, “Deposition path planning for material extrusion using specified orientation fields,” in 47th SME North American Manufacturing Research Conference, vol. 00, pp. 1-10, Elsevier, 2019, which is herein incorporated by reference in its entirety, is used as the basis for the LL-MA road planning algorithm presented here.

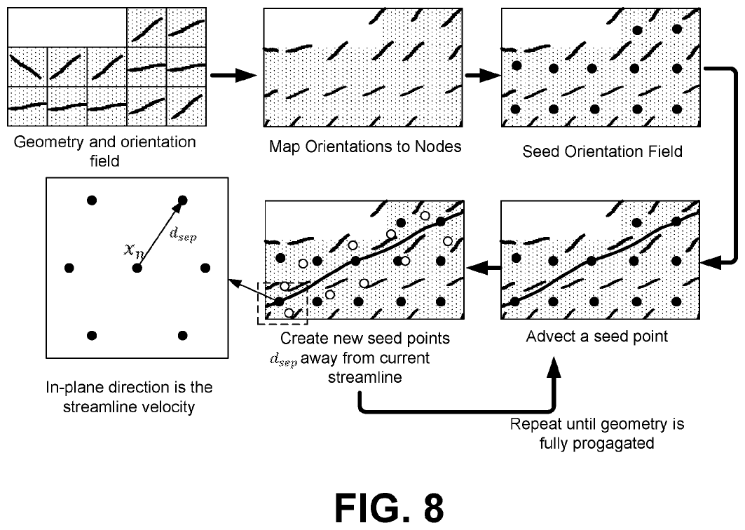

The algorithm is shown at a high level in FIG. 8. In particular, FIG. 8 illustrates a streamline placement process. In FIG. 8, the input orientation field is smoothed from a voxel-based representation to a node-based one to enable smoother velocity transitions. The geometry is then populated with an initial set of points and each is advected sequentially. During advection, additional seed points are placed around the streamline at each integration point in a hexagonal pattern. The algorithm exits once the geometry is fully propagated and there are no remaining seed points.

The voxel-based orientation field is mapped to the nodes of the mesh by averaging the values of the neighboring elements. This smooths the orientation field such that the velocity transition between each voxel is continuous, rather than discrete. For certain meshes (e.g., high-resolution), this step may not be necessary, as only a few deposition paths exist in each voxel.

Following, the orientation field is populated with an initial set of seed points. Each seed point is advected through the orientation field sequentially (i.e., in the order they were populated) using vector integration, where the orientation field acts as a bi-directional velocity field. At each integration point, additional seed points are created at some specified distance (dₛₑₚ) away from the integration point. If the streamline leaves the structure or comes within some termination distance (dₜₑᵣₘ) of another streamline, advection stops and the streamline is saved. Once all seed points have been addressed and the structure is fully propagated with streamlines, a linearization process takes place to generate linear roads for fabrication.

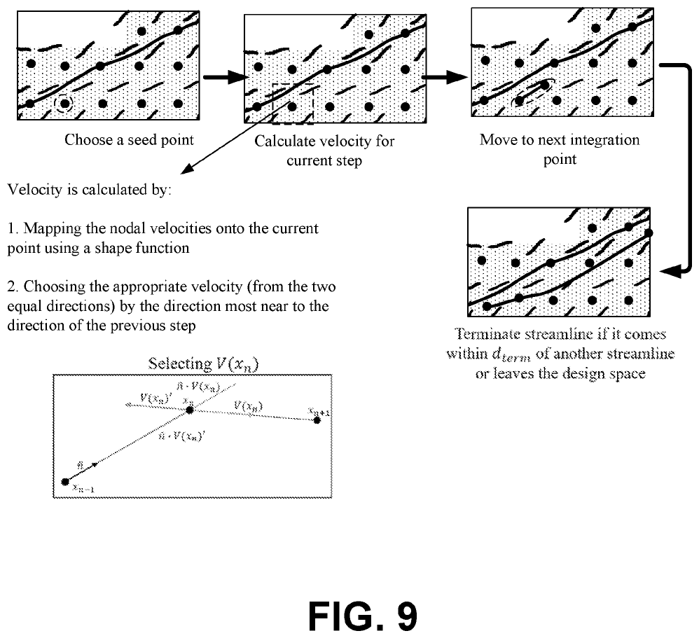

FIG. 9 illustrates the advection process used to propagate streamlines. At each integration point, the velocity is calculated for the current step by mapping the nodal velocities onto the integration point. The most appropriate of the two equal-but-opposite vectors is selected by dotting the direction of the previous step with each velocity. The positive dot product corresponds to extending the streamline, while the negative dot product roughly corresponds to wrapping the streamline back onto itself. Finally, the streamline is monitored at each integration point; if it comes within dₜₑᵣₘ of another streamline or leaves the design space, the advection process stops and another seed point is selected.

As shown in FIGS. 1A-1C, the orientation field is bi-directional. This means a given road could be fabricated from either end point, resulting in effectively the same deposition. Therefore, there are two possible velocities at each point in the orientation field. To select the appropriate velocity, first the nodal orientations are mapped onto the current integration point (using the eight-node quadrilateral shape function described in R. D. Cook, D. S. Malkus, M. E. Plesha, and R. J. W. Witt, Concept and Applications of Finite Element Analysis. 2002, which is incorporated by reference in its entirety). Second, the dot products between the previous integration step to (xₙ₋₁ to xₙ) and the two possible velocities for the current integration step are calculated. As the two possible velocities are equal in magnitude but opposite in direction, only one of the dot products will be positive. The velocity corresponding to the positive dot product is chosen for the current integration step, as that tends to create longer streamlines; the velocity corresponding to the negative dot product tends to wrap the streamlines back onto themselves.

The calculated integration point is validated during each step for proximity to other streamlines. If it comes within some termination distance, dₜₑᵣₘ, of another streamline, its advection is stopped. This prevents overlapping streamlines, which would correspond to over-deposited regions or colliding roads during printing. Similarly, advection is stopped if the streamline moves outside of the geometry.

After advection, the streamlines are spline-based curves, which may be difficult to fabricate using a given multi-axis platform. Therefore, the curves are linearized into roads using the chord length method (CLM). CLM spans the curve with a set of piecewise linear segments that attempt to minimize the chord height (i.e., the maximum distance between the linear segment and the spanned portion of the original curve). Specifically, the curve is linearized with a set of segments, each with a maximum length Lₘₐₓ, that does not exceed a maximum chord height dₗᵢₙ. If the specific deposition system being used does not require linear motions (e.g., it is capable of planning spline-based motion), this linearization step is not necessary.

In order to maintain perpendicularity of the deposition head during deposition, build directions must be assigned perpendicular to the road direction. Depending on the information contained within the orientation field, the build direction for each road can be assigned in one of two ways. The first assumes no build directions were specified in the orientation field; the build directions (\hat{b}) are assigned as the closest vector to the global Z-axis (\hat{z}) that is also perpendicular to the deposition direction (ñ). If convenient, other axes could be used for \hat{z} (e.g., minimizing support material by driving it to a nearby feature). If build directions are specified in the orientation field, they are instead assigned in terms of the closest vector to the average build direction of the voxels containing the road (\hat{b}). This process is captured in Equation 2.

$$\hat{b} = \frac{\tilde{n} \times \hat{z}}{\vert \tilde{n} \times \hat{z} \vert} \times \hat{n} \qquad ( 2 )$$

Propagation Parameters

The presented road propagation algorithm has a number of tunable parameters to customize it to a specific system and input. The dₛₑₚ and dₜₑᵣₘ parameters roughly correspond to infill density and air gap in typical XY-planar slicing software, respectively. For a fully dense part, dₛₑₚ should be set to the typical deposition width and dₜₑᵣₘ should be set to the minimum value that does not result in over-deposition. Additionally, to prevent a large number of very short roads, each streamline can be verified against a minimum length value (Lₘᵢₙ). If it is below this length, the original seed point is removed from the queue, but neither the generated streamline nor the additional seed points are saved. The linearization process can also be tuned through the maximum allowable chord height, dₗᵢₙ, and the maximum allowable linearized segment length, Lₘₐₓ. For a high-fidelity representation of the spline-based curve, dₗᵢₙ should be a minimal value. An additional point of note is that these parameter values do not necessarily need to be static throughout the entire workflow. It may be desirable to change the parameters when specific circumstances are met (e.g., for deposition paths with high curvature, it may be necessary to reduce Lₘₐₓ, or for deposition paths with long linear regions, it may be preferable to increase Lₘₐₓ to reduce the number of deposition paths during the collision detection step, etc.).

The method for seeding the design space also has a large impact on the resulting set of roads. The seeding pattern shown in FIG. 8 was chosen as it results in the highest packing density of evenly spaced circular cross-sections, but another pattern could be selected, as can be appreciated. The initial seeding strategy for the design space and the method for selecting the next seed point to advect could also be altered. In the present disclosure, support material voxels were initially seeded in the centers of their −Z surfaces while model material voxels were seeded in their volumetric centers. This ensured a more consistent first layer of support structure (improving adhesion to the bed) while allowing the model material to evenly populate each voxel's volume. After initialization, the seed points were addressed in the order they were created. Although these where the specific methods used in the examples in this disclosure, other initial and in-situ seeding strategies could be used without changing the remainder of the algorithm.

### Toolpath Ordering

The issue of ordering roads in a collision-free manner is directly analogous to the well-explored problem of ordering tasks with precedence constraints. In task-ordering problems, a precedence matrix C=[cᵢ,j] is created of size n by n where n is the number of tasks. If task i must precede task j, c_{i,j}=1, otherwise c_{i,j}=0. An ordering that satisfies the precedence constraints is found by transposing the rows and columns of C to create an upper triangular matrix C′. This is shown by considering a task i and any task j that occurs before it (i.e., i>j); if c_{i,j}=1, that means task i should precede task j, but does not. If c_{i,j}=0∀i>j, that satisfies the criteria for an upper triangular matrix. If an upper triangular C′ cannot be found, there are conflicting precedence constraints that cannot be resolved.

Although a polynomial-time algorithm has been presented for this problem, there are other considerations that need to be accounted for in the context of LL-MA ME. Specifically, in order to maintain the continuity of roads that share an end point, it is desirable to deposit certain roads in sequential order. Additionally, deposition head movement should be minimized to decrease print time. Due to the additional complexity imposed by these considerations, some embodiments of the present disclosure relate to creating a feasible, but not necessarily optimal, toolpath. In this context, a feasible toolpath is defined as any toolpath that is collision-free; an optimal toolpath is a collision-free toolpath that i) sequentially orders all roads that are possible to print continuously and ii) uses the minimum travel distance to connect the roads. The presented ordering algorithm takes place in two stages: i) establishing precedence constraints through collision detection and ii) ordering the precedence matrix with considerations for continuity and deposition head motion

### Collision Detection

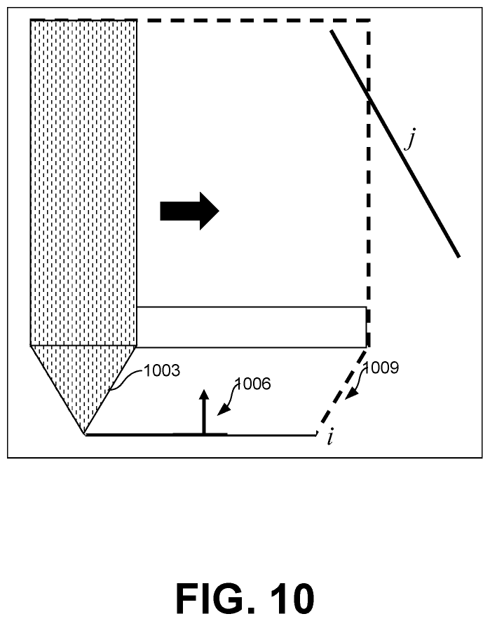

A precedence constraint occurs when the deposition head depositing a given road (i) requires volume occupied by another road (j). If road j lies in this volume, road i must be printed before road j (i.e., c_{i,j}=1). This situation is illustrated in FIG. 10. In particular, in FIG. 10, as the deposition head 1003 deposits road i at an orientation specified by the build direction 1006 of road i, it needs to occupy a certain volume 1009. If another road (j) occupies that volume, road i needs to be printed first in order to ensure the volume is available during printing. Algorithm 2 is used to establish these collision constraints.

Algorithm 2: Collision detection algorithm

| | Input: Tool, Rₛ, R_{f}, B | | | |
|---|---|---|---|---|
| | Output: C | | | |
| 1 | Tool Representative model of the deposition head (and motion control system if | | | |
| | necessary) | | | |
| 2 | Rₛ: Vector of start points for each road | | | |
| 3 | R_{f}: Vector of end points for each road | | | |
| 4 | B: Vector of build directions for each road | | | |
| 5 | n = the number of roads | | | |
| 6 | C = [c_{i,j} = FALSE] ∀ i, j = 1, . . . , n | | | |
| 7 | for ( i = 1; i <= n; i = i + 1 ) | | | |
| 8 | \| | Create the collison volume for road i by taking the Minkowski sum with Tool | | |
| 9 | \| | for ( j = 1 j <= n; j = j + 1 ) | | |
| 10 | \| | \| | Create the collision volume for road j | |
| 11 | \| | \| | Detect collisions between roads i and j | |
| 12 | \| | \| | if collision then | |
| 13 | \|_ | \|_ | \|_ | c_{i,j} = TRUE |

At a high level, a conservative (convex) model of the deposition head is created that fully encapsulates the actual volume of the deposition head. Then, for each road, the Minkowski sum of the deposition head model is taken over the length of each road, with the model oriented along the build direction of the road, to create the collision volume. Additionally, a collision volume for each road is created by sweeping the expected deposition cross-section along the length of the road. Finally, the deposition head collision volume for each road is compared to the collision volume of each other road in the structure (resulting in n² comparisons, where n is the number of roads). In the present disclosure, an initial check was performed between collision volumes to ensure they were in the same neighborhood. If so, the Gilbert-Johnson-Keerthi (GJK) algorithm of E. Gilbert and D. Johnson, “A fast procedure for computing the distance between complex objects in three space,” Robotics and Automation., vol. 4, no. 2, 1987, which is herein incorporated by reference in its entirety, was used to verify if a collision occurred (e.g., if a precedence constraint needed to be created).

This method assumes the motion control system (e.g., the robotic arm) will never collide with the part and therefore does not need to be considered. According to various embodiments of the present disclosure, the part being printed is small relative to the deposition head, so this assumption is appropriate. If larger parts are to be fabricated, it may be necessary to also compare the collision volume occupied by the deposition system as each road is deposited. Regardless, the overall process remains the same.

If the part is larger than the deposition head (and therefore requires explicit consideration of collisions with the deposition platform), the algorithm can be modified to accommodate. Constructing a convex approximation of the deposition platform is likely difficult; therefore, the Minkowski sum and GJK algorithm are not suitable. Instead, inverse kinematics (IK) could be solved for the road using the assigned build direction. The resulting joint angles place the deposition platform in the environment as they would be during fabrication of a road (i). Therefore, at each joint angle, collisions should be calculated between the deposition platform and all roads (j). This process, like the deposition head-only algorithm, is generalizable to any deposition system (i.e., can be applied to more than the 6-DoF robotic arm used in this work). An additional benefit is that collisions between the deposition system, part, and any environmental obstacles are also easily calculated using this method.

### Road Ordering

The result of the collision detection algorithm is a square collision matrix C that must be permuted to an upper triangular matrix C′ to satisfy the precedence constraints. To maintain the correct precedence constraint referencing, this reordering must be performed with coupled row-column permutations (e.g., if rows 1 and 2 are permuted, so must columns 1 and 2). The vector P that permutes C to upper triangular form is a collision-free ordering.

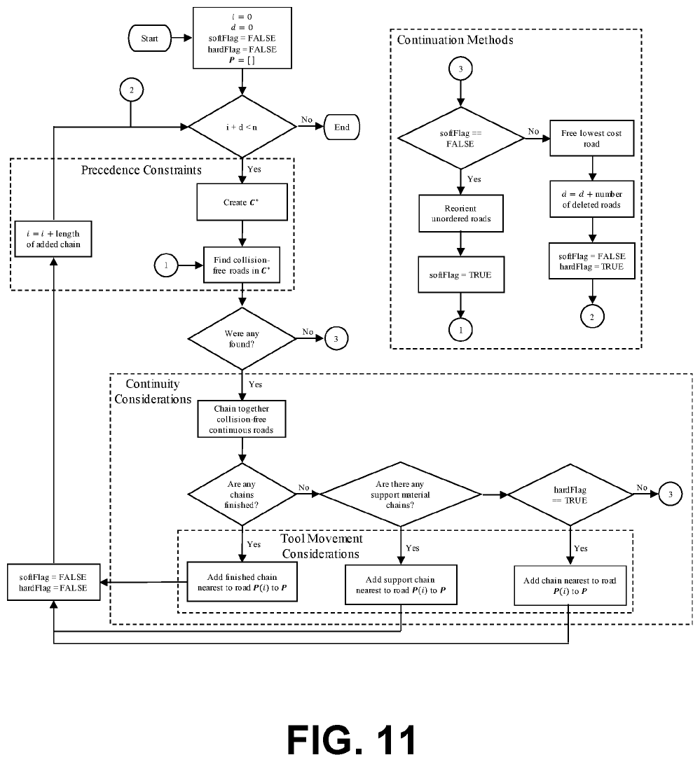

The algorithm used in the present disclosure to create P that considers precedence constraints, continuity, and deposition head movement is illustrated in FIG. 11. In particular, FIG. 11 illustrates a high-level overview of the ordering algorithm used to create a collision-free toolpath. Considerations for precedence constraints, road continuity, and minimizing deposition head movement are included. At a high level, the algorithm searches the unordered sub-matrix of C (C*) for collision-free roads and attempts to chain those roads together to preserve continuity. When possible, the algorithm adds completed chains to the toolpath (P) and continues by creating a new sub-matrix C*. If it cannot continue (e.g., no collision-free roads can be found), the algorithm attempts to address conflicting precedence constraints by i) reorienting the build directions of the unordered roads and ii) removing low value roads from the toolpath. Additional details on each of the highlighted regions in the flowchart are given in the following paragraphs.

Precedence Constraints. The precedence constraints represented in C are satisfied by first assembling a sub-matrix C* of all of the unordered roads (i.e., the roads that have neither been added to P nor deleted from the toolpath). Second, this sub-matrix is searched for collision-free roads which are denoted by an empty row in C*. Without considerations for tool movement or continuity, these roads can be added to P without introducing collisions.

Continuity Considerations. If two roads share an end point, it is ideal to print them sequentially to preserve the continuity of the roads. Therefore, the collision-free roads, found in the previous step, that share an end point are grouped together to form chains. If a chain is complete (e.g., the end points of the chain are not shared by any unordered road), it can be added to P without introducing deposition discontinuities. In the case that no chains can be completed, the algorithm may also permit adding incomplete support material chains to P, as those do not contribute to the final performance of the structure. Further, if all of the continuation methods have been used without anything being added to P, any started chain can be added to P to guarantee a toolpath may be generated.

Tool Movement Considerations. In the case that multiple chains are suitable for adding to P, in various embodiments, the algorithm may attempt to minimize the movement of the deposition head. The algorithm may check both end points of each candidate chain and minimizes the distance to the last-added road in P. Only the chain with the minimum distance is added to the P.

Continuation Methods. According to various embodiments, it is often possible for C to not have a possible upper triangular permutation. In these situations, there is not a P that produces a collision-free toolpath. This is encountered when there are no collision-free candidates available to create chains. In these situations, the algorithm removes a subset of the roads from the toolpath in order to continue. To minimize the impact on the final structure, this subset of roads is determined by i) calculating the cost to free each remaining road, using the cost equation in Equation 3, and ii) freeing the road with the minimal cost.

$${s}_{i} = {\sum }_{j = 1}^{n} {c}_{i , j} * {l}_{j} \qquad ( 3 )$$

sᵢ is the cost to free (i.e., make collision-free) road i, and lⱼ is the length of road j. Essentially, there are roads preventing the disassembly of each other road in the toolpath; in order for the algorithm to continue, the one with the shortest length of roads preventing its disassembly is freed. To free the lowest cost road, the restricting roads are removed from the toolpath by clearing their associated rows and columns in C and C*, guaranteeing at least one collision-free road in C*. Although this ensures the algorithm will finish, it may be necessary to delete a large number of roads for a complex toolpath, resulting in a structure with compromised integrity and strength.

An additional continuity method may be implemented in order to improve chain length. Specifically, if chains cannot be finished, the unordered roads are searched for collision-free build directions. The build directions of the roads in C* are rotated, and collisions are recalculated. This process can be repeated any number of times, rotating the build directions of the unordered roads further each time.

Multi-Axis Example

In order to validate the presented LL-MA workflow, the LL-MA workflow was applied to an example geometry and orientation field. One quarter of a TO Wheel is used as the input for this case study, which was optimized in terms of both geometry and material orientation. The TO algorithm prescribes optimal deposition and build directions to form the orientation field required for various embodiments of the present disclosure.

In the TO output, each voxel had an edge length of five (5) mm, resulting in a printed part size of 75 by 75 by 70 mm. The geometry and orientation field of the TO output can be used for validating the presented LL-MA workflow. The presented LL-MA workflow is used to produce a printable toolpath for the input, and then the toolpath is fabricated using a multi-axis ME system. Each module of the workflow is then evaluated in terms of their contributions to the final toolpath.

Multi-Axis Deposition System

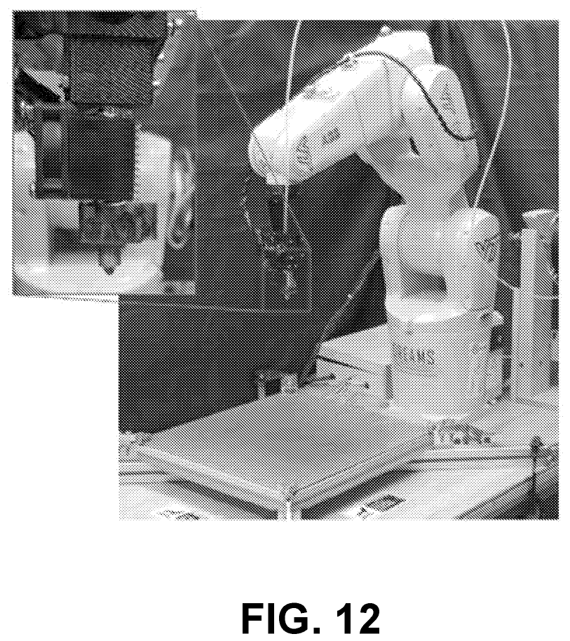

The multi-axis ME system used to fabricate the example geometry and orientation field is shown in FIG. 12. In particular, FIG. 12 illustrates an example photograph of a 6-DoF ME system used to fabricate the example geometry and orientation field. It consists of a robotic manipulator, a desktop-scale deposition head that has been modified for LL-MA ME (inset image), and a heated build platform. In particular, the system of FIG. 12 features an ABB® 1200 7/0.7 robotic arm outfitted with a desktop scale deposition head. The deposition head was modified by elongating the hot-end and sharpening the nozzle to create a smaller interference angle. This reduces the size of the collision volume (shown in FIG. 10), enabling a wider range of collision-free orientations for the deposition head. In turn, the number of collisions found using Algorithm 2 is reduced, increasing the overall flexibility of the system.

To interface with the ABB arm, the toolpath must be formatted as RAPID code, which is effectively a list of poses for the deposition head (e.g., XYZ-coordinate and quaternion pairs that describe position and orientation, respectively). Therefore, following the ordering step of the present disclosure, each road is converted into coordinate and quaternion pairs with appropriate (i.e., collision-free) travel movements. Extrusion timing is directly controlled by the robot as described in J. R. Kubalak, C. D. Mansfield, T. H. Pesek, Z. K. Snow, E. B. Cottiss, O. D. Ebeling-Koning, M. G. Price, M. H. Traverso, L. D. Tichnell, C. B. Williams, and A. L. Wicks, “Design and Realization of a 6 Degree of Freedom Robotic Extrusion Platform,” Solid Freeform Fabrication Symposium, pp. 1314-1332, 2016, which is herein incorporated by reference in its entirety.

Road Propagation

Roads for both the model and support structure of this example were propagated using the road propagation algorithm of the present disclosure and using the parameters outlined in Table 1.

TABLE 1

| | | Model | Support |
|---|---|---|---|
| Variable | Description | Value | Value |
| dₛₑₚ | Seed point separation distance | 1.3 | 1.4 |
| dₜₑᵣₘ | Streamline termination distance | 0.7 | 1 |
| Lₘᵢₙ | Minimum streamline length | 2.5 | 2.5 |
| dₗᵢₙ | Maximum linearization | 0.35 | 0.5 |
| | chord length | | |
| Lₘₐₓ | Maximum linearized road length | 5 | 5 |

These parameters were experimentally established to produce a dense model structure with minimal support. The support material values for dₛₑₚ and dₜₑᵣₘ were increased from the model material in order to produce a support structure with a lower density. dₗᵢₙ was increased for the support material as the support roads did not need to follow the generated orientation field with the same level of accuracy. Instead, it was more beneficial to decrease the number of support roads (by making each individual road longer) to improve performance in the collision detection and ordering modules.

In the model structure, the model road directions qualitatively followed the desired orientations. Additionally, the model structure included continuous roads linking all of the geometric features together. This is particularly important in the convergent region in the top center of the structure, where discontinuous roads would likely prevent bonding between the features.

In the model structure, the support roads that interface with the model roads were orthogonal, as desired, which enables the deposited model material to contact multiple support roads. The spacing at the interfacing region is mesh dependent though, as the discretized slope can result in gaps larger than the desired separation distance. Specifically, this is caused by the minimum length parameter, Lₘᵢₙ, as the sharp corners on the discretized slope cannot be appropriately filled from either the support or model material sides of the interface.

Toolpath Ordering

A convex approximation of the deposition head, shown in FIG. 12, was used for the collision detection step. The geometry used a cone, with an angle of 50° and a height of 80 mm, and a cylinder with the same radius as the top of the cone that continued to the extent of the design space (approximately shown in FIG. 10). This composite shape overestimates the volume required by the deposition head, ensuring no false-negatives are produced during the collision detection step.

The reorientation continuation method parameters were Δθ=5° for each iteration of the build direction search with a maximum deviation of ±30° from the original build direction. To prevent collisions between the robot and the build platform, negative build directions were not allowed. Additionally, to prevent collisions between the deposition head and the build platform, build directions more than 40° from the global Z-axis were not allowed below 95.34 mm (the radius of the deposition head model). This constraint prevents the deposition head from assuming steep orientations until the deposition head is sufficiently above the build platform.

According to various embodiments, the present disclosure relates to finding a feasible toolpath. The fabricated part is heavily influenced by the quality of the toolpath. To this end, three metrics were used to evaluate the produced toolpath:

Collision-Free. In order to be a feasible toolpath, it must be collision-free (i.e., upper triangular). This binary metric can be evaluated using collision matrices. In particular, collision matrices can illustrate model road collisions and support roads.

Continuity. Ideally, all of the roads that share an end point should be printed sequentially to improve mechanical performance. To determine the number of roads that were properly sequenced, a continuity matrix (Y) is created using the ordered toolpath. In results, an unordered continuity matrix illustrated perfect continuity as the roads are still in the order they were generated. The ordering resulted in 3548 properly sequenced continuous roads out of a total of 7098 (1357 continuous model roads were sequenced properly out of 3013). In particular, the generated matrix can represents the number of roads that could have been printed sequentially in order to preserve continuous road length. For example, if road i shares an end point with road j, y_{i,j}=1 and y_{j,i}=1. In a perfect ordering in terms of continuity, road i will immediately precede or follow road j for all connected roads i and j; this places the non-zero indices of Y on the second diagonals. Although the unordered toolpath is not collision-free, a resulting continuity matrix illustrated a perfect ordering for continuity.

Deleted Roads. The number of roads that had to be removed in order to produce a feasible toolpath should be minimized in order to preserve the shape and mechanical performance of the produced structure.

During the ordering step, multiple roads had conflicting build directions, in particular around the right-hand side of the structure. This was due to the slope of the model material relative to the angle of the deposition head. Although the reorientation routine attempted to repair these conflicts, the algorithm was unable to find suitable build directions for many of the roads and resorted to removing them from the structure. The ordered collision matrix is collision-free as evidenced by the upper triangular shape of the matrix. A total of 1312 roads were removed, with 1225 of them being support roads and 87 model roads (out of a total 5909 and 4790, respectively). In the results, a total of 7098 roads could have been ordered sequentially, but the ordering algorithm was only able to sequence 3548 of them (including 1357 sequenced model roads out of a possible 3013). As a result, the toolpath stops depositing a model chain and returns to it later in the toolpath 1656 times. Although this is a feasible toolpath, it is likely not optimal due to the large number of discontinuous roads and the number of roads that needed to be deleted.

Printing

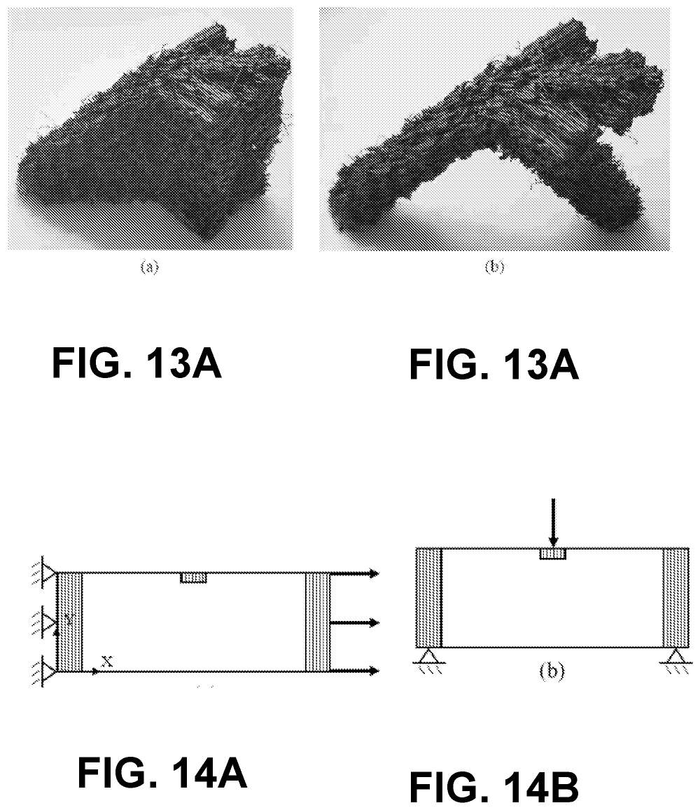

The fabricated example geometry is shown in FIG. 13. In particular, FIG. 13 illustrates a fabricated quarter Wheel geometry. FIG. 13A illustrates the support structure was too sparse along the Z-axis to maintain the typical linear roads, resulting in poor deposition quality, but it was still sufficient to support the deposition of the model material. FIG. 13B illustrates an image of the geometry that shows that after removing the support structure, the printed part qualitatively matches the input geometry and orientation field.

During fabrication, the support structure lost significant structural integrity due to i) the sparsity of the roads along the Z-axis and ii) the deletion of a number of support material roads during the ordering step. These issues caused many of the support material roads to produce non-linear, nearly sinusoidal depositions. Although undesirable, this did not cause issue with the overhanging geometries in the actual part, as the model material still adhered well to the support structure and cooled in the desired positions. However, using a different seeding strategy during the support material propagation step should result in a reduction in XY-plane density and an increase in Z-axis density, improving the overall integrity of the support structure.

Another point of note, that is not apparent in the final printed structure, is the short and discontinuous depositions utilized by the system during fabrication. This was caused by i) the model material propagation step producing a large number of shorter streamlines (and subsequently shorter linearized roads) and ii) many longer-length road chains being broken up during the ordering step.

Planar Example

As another example of the described workflow, this section applies the workflow to a planar orientation field. In this case, the orientation field and geometry are a 2.5D planar geometry. As such, support structure is not required. Additionally, the planar nature of the orientation field implies planar deposition paths; explicit collision constraint calculation is not required (but could be used if desired). The deposition paths can instead be ordered in terms of ascending Z-height (as with typical XY-planar deposition). The following subsections detail the nature of the orientation field and the results of each of the used workflow modules.

Geometry and Load Cases

In an example, the planar geometry and orientation field for a structure was created using the two load cases. In the example, a i) pure tensile load and ii) three-point bending load were optimized for simultaneously using the algorithm described in Kubalak. Fixed regions can be used to allocate regions to mount fixturing for mechanical testing. FIGS. 14A and 14B illustrate example load cases that were used to optimize the planar geometry.

Road Propagation

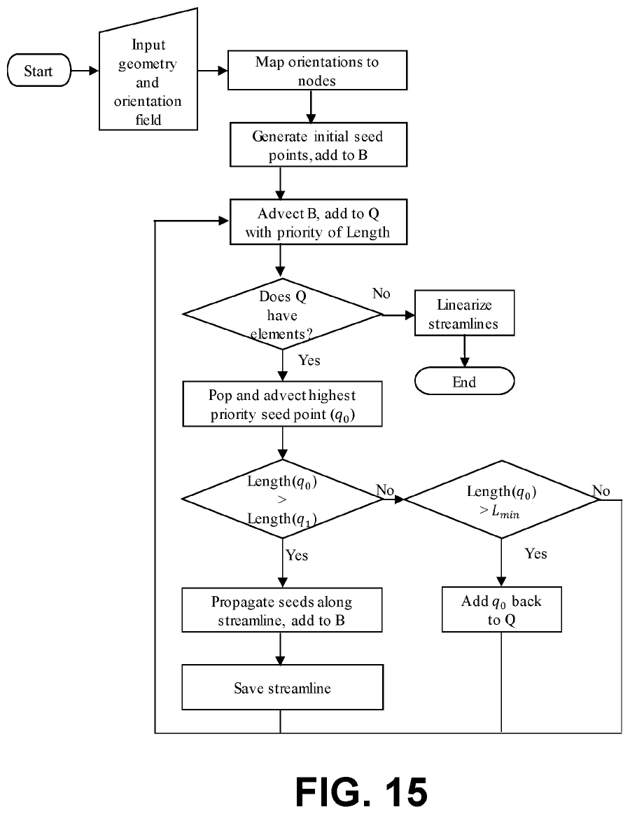

The deposition paths were propagated using the same hexagonal seeding pattern and propagation parameters used in the multi-axis example (Table 1). In this case, to improve the length of each streamline, the seed points were addressed in a double-queue. FIG. 15 describes this version of the algorithm at a high level.

As illustrated in the figure, the orientation field is mapped to the nodes and additional seed points are propagated (as in the multi-axis example). Rather than advecting individual seed points on a first-in first-out basis, all of the seed points are advected using the current state of the design space for proximity detection. Following, the lengths of those advected streamlines are used to rank the seed points in order of priority. The longest streamline (i.e., the highest priority) is saved as a streamline in the toolpath, and seeds are propagated along its length. Those created seed points are all simultaneously advected through the orientation field.

This process repeats, popping the highest priority seed from the ranked queue until the longest streamline in the queue is less than Lₘᵢₙ. In case the state of the saved deposition paths has changed since the previous iteration, the highest priority seed point is re-advected. If its length is less than the next highest seed point, it is re-added to the seed point queue with its new length as its priority weight. If the new length is less than Lₘᵢₙ, it is not re-added to the queue.

Toolpath Ordering

The toolpath resulting from the planar orientation field does not require explicit collision detection in order to establish a collision-free ordering. Instead, the collision matrix can be established in ascending order (i.e., if deposition path i is above deposition path j, c_{i,j}=1. In this way, the resulting collision matrix will ensure that the toolpath is deposited layer-by-layer. The algorithm described in FIG. 11 can be used to establish an ordering. In this case, it is guaranteed that a collision-free toolpath can be generated. In some instances, the algorithm can be flexible to the type of input (e.g., user input when the user has particular knowledge about the object). For example, it may be more efficient to use more typical ordering algorithms seen in XY-planar deposition.

In this disclosure, collisions were established using the described ascending order analysis and the algorithm in FIG. 11 was used to order the toolpath. As it was a planar geometry and orientation field, no deposition paths needed to be deleted and the deposition paths could be printed with complete continuity. That is to say, an upper triangular C′ was found, and all of the non-zero entries in the continuity matrix Y were on the second diagonals.

Printing

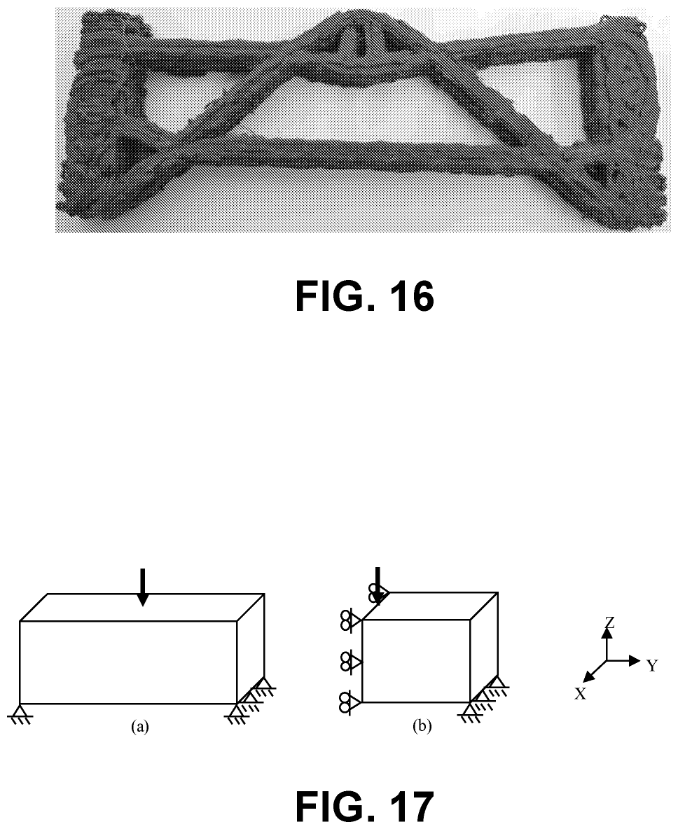

The resulting toolpath was printed using the robotic deposition platform shown in FIG. 12, but the toolpath could have been printed on any 3-DoF or multi-axis system due to its planar nature. The resulting part is shown in FIG. 16. As seen, the artifact is comprised of many long-form deposition paths that cross multiple joint regions, which should improve the overall strength of the part in the prescribed loading conditions.

LL-MA ME enables significant customization in terms of the toolpath used to fabricate a part and, as a consequence, the properties of the part. Although there have been a number of works on multi-axis ME, they typically focus on either i) constraining the build and deposition directions to ensure printability or ii) the fabrication of geometries that are effectively curved layers stacked along a single direction. The present disclosure provides a workflow that generalizes the task of generating LL-MA toolpaths, with no restriction on geometries or the orientation field that can be supplied. As such, this workflow enables i) the free orientation of build and deposition directions and ii) the fabrication of multi-axis structures constructed of unconstrained roads (as opposed to roads constrained to planar or curved layers). In the present disclosure, the orientation field was defined according to the load paths through the geometry, but any other criteria could be used to define an orientation field (e.g., (e.g., thermal conductance/dissipation, fluid/material flow, electrical conductance, mode shapes, natural frequencies, stiffness, stress, (e.g., von Mises), etc.). The workflow is designed such that any geometry and orientation field, regardless of the selected criteria, is acceptable.

The workflow of the present disclosure leverages a voxel-based representation of the geometry and an associated orientation field that describes the desired deposition directions (and if desired, the build directions) throughout the part. The input geometry and orientation field is then processed using the modular workflows shown in FIGS. 5A and 5B. It should be noted that although the present disclosure provides various embodiments associated with the algorithm, the overall intent of the workflow is unaffected.

Support Generation. The typical method of propagating support structure in XY-planar ME is insufficient for multi-axis ME due to the use of variable build directions. In the workflow of the present disclosure, support structure is propagated along the build directions of each voxel of the model as described in Algorithm 1. In order to ensure the support structure is also supported, the algorithm is an iterative process that drives the support structure to the build platform.

Road Propagation. The voxel-based input specifies desired road directions within each voxel. In order to align roads with these desired directions, an algorithm leveraging iterative advection is used, as shown in FIG. 8. The algorithm explicitly aligns roads with the input orientation field and volumetrically fills the geometry. In order to facilitate multi-axis deposition, build directions must be assigned to each road. Depending on the type of orientation field, these build directions can either be i) extracted directly from the orientation field or ii) assigned orthogonal to the road direction.

Toolpath Ordering. LL-MA roads change Z-height along their length and therefore cannot be ordered in terms of ascending Z-height. If the roads are improperly ordered, the deposition head will likely collide with previously deposited material. In order to maintain generality for arbitrary geometries and orientation fields, the collision constraints between each road are explicitly defined and then satisfied through the matrix sorting algorithm illustrated in FIG. 11.

Workflow Verification. The presented workflow was demonstrated on two geometries: i) a TO Wheel geometry that featured a number of overhanging geometric features and a wide range of road and build directions and ii) a planar optimized geometry featuring two load cases. In the second example, support generation and explicit collision checking were not required, but the overall workflow was still able to produce a toolpath consisting of long, continuous deposition paths. In the multi-axis example, the workflow propagated suitable support structure for the build directions and deposition paths aligned to the input orientation field.

In the multi-axis example, the ordering algorithm produced a feasible toolpath but required the removal of 1312 roads. Despite the removal of 20.7% of the support material roads, the structure was successfully fabricated on a 6-DoF platform. Due to the planar nature of the multi-load example, no roads needed to be removed during the ordering step, and the deposition paths were printed with complete continuity (i.e., all deposition paths that shared an end point were printed sequentially).

Due to the ability to preferentially align roads with any anticipated loading conditions using LL-MA deposition, the strategy has the potential to significantly improve the mechanical performance of ME parts as compared to XY-planar or surface-constrained multi-axis deposition. Improvements to the present disclosure for each module are outlined below.

Support Structure. The support structure generated for the presented geometry constituted approximately 62% of the deposited material. By tuning the assigned build directions for the support structure, it should be possible to reduce the volume of the generated support by leveraging critical deposition angles. Additionally, support structure could extend to and from other geometric features rather than being driven to the bed. Implementing these techniques would reduce both print time and the computation time required for road propagation and toolpath ordering.

As demonstrated in the planar example, it is possible to use portions of the workflow without generating explicit support structure. Other opportunities for minimizing or eliminating support structure could be explored including penalizing or constraining build directions during optimization to produce a structure that is self-supporting. Support-free build directions have been explored in a multi-axis context previously, and the geometric features of a planar geometry have been optimized to be support-free. Other opportunities could include materials design or process parameter optimization such that the deposited material sets (or cools) immediately upon deposition. In this way, it would not require support structure following deposition. While these opportunities and deposition strategies would make the support generation step unnecessary, they do not change the other modules of the outlined workflow.

Road Propagation. The propagated roads within the printed model were shorter than desired; more intelligent seeding and queueing strategies should result in more continuous roads. As demonstrated in the planar example, a priority queue can be used to improve the length of the produced streamlines (relative to the multi-axis example). Examples from literature have used other strategies like furthest-point seeding to start new streamlines as far away from existing streamlines as possible to promote long-form, continuous streamlines. This should improve the quality of the final structure as well as reduce print time due to fewer travel movements.

Additionally, the support material was too sparse along the global Z-axis to maintain structural integrity while also being denser in the XY-plane than necessary. In the present disclosure, the same hexagonal seeding strategy was used for both the model and support material. While the hexagonal pattern does result in a high packing density of roads, when intentionally introducing sparsity (e.g., reducing the density of the support structure), the hexagonal pattern does so isometrically rather than strictly in the XY-plane. Therefore, a new strategy for propagating seed points that does so anisometrically (e.g., a rectilinear pattern with different spacing in- and out-of-plane) may produce better results.

The examples present in this disclosure select the appropriate velocity for advection of the streamline by dotting the previous velocity with the bi-directional velocities of the current step. Although this was shown to produce continuous streamlines, it may be advantageous to search the design space by advecting along both velocities at each step. In this way, the streamline can better accommodate new velocity vectors that are nearly orthogonal to the current step. For instance, if the dot products are very near zero using the current method, neither velocity will likely wrap the streamline back on itself. By exploring both velocities at each step, the average streamline length would likely be improved.

Other possibilities also exist for generating multi-axis deposition paths. For instance, direct propagation of the deposition paths could occur during the TO step. Known work has been done to directly optimize the topology of the infill in addition to the external contours of the geometry. Currently, these methods do not directly produce a toolpath (i.e., printable deposition paths) and require further post-processing to do so. Another option could be to first populate the structure with a set of iso-surfaces and then connect those isosurfaces with deposition paths.

Toolpath Ordering. The current method of ordering the roads is computationally expensive (requiring approximately 90% of the total computation time). Additionally, the matrix sorting algorithm results in a number of roads printed discontinuously and requires the removal of a large number of roads (12.3% in the Wheel example). Literature has demonstrated other methods for ordering tasks (e.g., through the Chinese Postman Problem and the Traveling Salesman Problem), which could be more suitable for this application. By selecting appropriate weights for the graphs in these problems, it may be possible to arrive at an optimal toolpath in terms of minimizing tool head movement.

Multiple Deposition Heads. Systems with multiple materials or deposition heads could be adapted to use the outlined algorithms. For instance, the deposition path propagation algorithm could be used on any number of sub-voxel maps (e.g., the support and model material voxel maps already demonstrated in this disclosure) or certain deposition paths could be assigned to different tool heads. In the ordering module, disassembly can be performed such that (for example) i) each tool head is moving simultaneously as often as possible or ii) the number of required tool changes is minimized

Topology Optimization

As discussed, material extrusion (ME) is an additive manufacturing (AM) process in which material (typically a heated thermoplastic) is selectively deposited to fabricate a desired part geometry. This process typically operates in a layer-by-layer manner that, due to the thermal characteristics of material deposition, introduces imperfect bonds between each layer and between adjacent depositions within a single layer. The final mechanical performance is therefore anisotropic, dependent on both the build and deposition directions, where the part is stronger along the continuous depositions than the inter-layer and intra-layer bonds. This anisotropy is further accentuated when using composite materials, as the ME process produces a high degree of alignment in the composite reinforcement with respect to the direction of deposition (illustrated in FIGS. 4B and 4C).

With three (3) degrees-of-freedom (DoF) ME, part designers are recommended to orient their parts such that loads are applied exclusively along the depositions within each layer. For parts with simple loading conditions, it might be possible to find an orientation that conforms to this rule, but it is often not possible for complex (e.g., multi-axial) loading conditions. Therefore, in some areas of the part, material will be in sub-optimal orientations with respect to the load, requiring design compromises to compensate (e.g., additional material in critical areas).

The 3-DoF tools used in ME systems limit the deposition strategy to unidirectional stacking of XY-planar layers. Incorporating additional DoF into the deposition system would enable other strategies (e.g., FIG. 4C)) by allowing the tool head and part to reorient relative to each other, as with the 6-DoF robotic arm ME system shown in FIG. 12. Specifically, this would allow for better alignment of the material in regards to the applied loads and reduce the need for design compromises in order to maintain part performance. Referred to here as multi-axis (MA) ME, these strategies have been used to improve the performance of hemispherical pressure caps, tensile bars through conformal surface reinforcement, and optimized 2.5D surface geometries relative to geometrically similar parts printed with XY-planar layers.

Although traditional methods have the potential for mechanical performance improvement using MA-ME, there are shortcomings in their toolpath planning capabilities. Specifically, the demonstrated MA geometries were surfaces, not true 3D parts. Similar toolpaths could be generated using curved layer slicing techniques and assigning tool head orientations normal to that curved surface. While effective, there are many geometries that are not able to be decomposed in this manner; in more complex loading conditions and geometries, these strategies would likely result in sub-optimal material usage.

In order to use MA-ME to fabricate optimized 3D parts, the present disclosure provides a toolpath planning technique that (i) determines material orientation throughout the geometry and (ii) plans deposition paths for a MA-ME system throughout that optimized geometry. As a first step toward this goal, the present disclose provides a topology optimization (TO) problem formulation with considerations for the 3D orientation of an anisotropic material. The discussed method simultaneously optimizes material distribution (e.g., part topology) and material orientation within the design space. In the context of MA-ME, the resulting optimized orientations denote the deposition directions and the intended tool head orientations (i.e., build directions) throughout the geometry.

Topology Optimization with Material Orientation Considerations

TO is a family of optimization techniques that find the optimal material distribution (e.g., structure) within a given design space for a prescribed set of loading and boundary conditions. The geometric freedom afforded by AM technologies has better enabled the fabrication of TO-generated structures, but AM-specific manufacturing constraints and considerations are still necessary. For instance, TO formulations have been presented in literature to ensure self-supporting optimized geometries, enforce minimum feature size constraints, and optimally distribute multiple material types.

In the same vein, the challenges of anisotropic mechanical properties must be considered in the optimized geometries. A commonly used TO method, solid isotropic material with penalization (SIMP), finds the optimal material layout through a finite element approximation of the design space. SIMP has been adapted to enable the use of orthotropic and anisotropic material properties, but in its typical formulation, SIMP does not have considerations for material orientation. When designing for anisotropic materials though, the orientation has a large impact on the final performance of the structure. Therefore, extensions to SIMP have been developed that incorporate material orientation considerations.

By Michell's theorem, the truss members within an optimal structure coincide with the paths of principal stresses when subjected to a single loading condition. This theorem has been used to develop methods of determining material orientation along lines of principal stresses and principal strains. These methods have also been adapted for use in multiple loading cases. For complex loading conditions though, more flexibility is often required of the orientation optimization technique.

A more direct and flexible method of optimizing material orientation is to directly control the orientation through additional design variables. One method of parameterizing the orientation space is through continuous fiber angle optimization (CFAO), whereby a Euler angle design variable is assigned to each element in the design space. The CFAO method has been demonstrated in the context of cellular automata and for shell structures. CFAO has also been used to inform a 3-DoF (XY-planar) ME process; printable toolpaths were generated using contour-based deposition paths as, by Michell's theorem, the orientations followed the contours of the density paths. Mechanical testing of optimized Messerschmitt-Bölkow-Blohm (MBB) beams demonstrated a 30% improvement in sustained compressive load by the CFAO specimens relative to a non-reorientable orthotropic material model. Other known methods have used an extension of the CFAO algorithm to create geometries for a planar multi-material jetting AM process. The microstructure of each element (consisting of a two-phase short-fiber composite) was oriented within each element using two design variables to enable non-planar orientations. To create a toolpath, the microstructure was voxelized along the build direction such that the fibers were printed across multiple layers

The CFAO method has issues with local minima though, stemming from the Euler angle parameterization of the orientation design space. To address this issue, two orientation design variables can be used represent the planar orientation of each element and a natural coordinate system has been mapped onto a physically meaningful orientation space. While this is not a minimum representation of the orientation space (e.g., the parameterization requires additional design variables per element to represent the orientation), the method was shown to have little issue with converging to local minima. Discrete material optimization (DMO) also does not use a direct Euler angle variable, but instead uses a weighted sum of discrete material orientations to reduce issues with local minima. Free material optimization (FMO) optimizes for the values of the material properties directly, rather than the material orientation, which enables significant freedom in material design.

Although there are a number of TO formulations that enable the variation of material orientation, not all of them are suitable for application to the ME process. For instance, FMO allows for the infinite variation of material properties throughout the design space, but fabrication of the results may not be feasible. The ME process is often limited to the deposition of a single material, which would require constraints to be placed on the FMO algorithm in order to produce a realizable result. On the other hand, DMO relies on a set number of allowable material orientations, which restricts orientation variation. Optimal deposition paths are typically highly organic curves that would be difficult to capture with a predetermined set of allowable orientations. Additionally, the results of DMO algorithms are dependent on the chosen weighting function and require unit weight constraints to ensure physically realistic results. Therefore, CFAO and the extension discussed in Nomura, T., Dede, E. M., Lee, J., Yamasaki, S., Matsumori, T., Kawamoto, A., and Kikuchi, N., 2015, “General Topology Optimization Method With Continuous and Discrete Orientation Design Using Isoparametric Projection,” Int. J. Numer. Methods Eng., 101(8), pp. 571-605, which is incorporated herein by reference in its entirety, which allows for the infinite variation of a single set of material properties, are used as the basis for the presented algorithm. There are a number of parameterizations for 3D orientations though, and the chosen parameterization has a large impact on both the efficiency of the algorithm and the quality of the final result.

Impact of Orientation Parameterizations.

To fully leverage the capabilities of MA-ME, material alignment must be varied in 3D, which requires treating the 3D orientation of the material in each element as a design variable. Due to the non-convexity of these orientation spaces, the parameterization chosen for the optimization process has a large impact on the performance of the algorithm. Specifically, singularities and local minima are large issues in orientation optimization, both for the final solution fitness and the speed of convergence. To this end, three parameterizations of the orientation design space are explored in this work: (i) Euler angles, (ii) quaternions, and (iii) natural quaternions.

Each parameterization is demonstrated using two benchmark compliance minimization problems, the MBB beam and the Wheel problem, and a combined loading case featuring (i) pure tension and (ii) three-point bending. The parameterizations are compared in terms of their final solution fitness and the number of iterations required for convergence. As a point of comparison to existing TO algorithms, a CFAO algorithm is also used for each problem. It is hypothesized that (i) for the 2D loading cases, the parameterizations will produce equivalently compliant structures to the CFAO algorithm and (ii) the 3D parameterizations will result in improved compliance values for 3D loading conditions, relative to the CFOA algorithm, due to the increased orientation flexibility.

Three-Dimensional Orientation Parameterizations

Many different parameterizations exist for representing orientations including Euler angles, axis-angle parameters, direction cosines, and quaternions. In the context of an optimization problem, the choice of parameterization has a large effect on the efficiency of the algorithm as well as the quality of the final solution. Three different parameterizations, described in the following subsections, are explored in the present in an effort to find an effective and efficient set for TO with considerations for 3D material orientations.

Euler Angles.

CFAO uses a planar simplification of the Euler angle parameterization and has been extended to non-planar orientations, but both CFAO and other known methods are insufficient to describe the orientation variation possible with the MA-ME process. Specifically, the jetting process in one known method only requires two Euler angles to properly describe, as it has no ability to reorient material properties orthogonal to the fiber direction. In contrast, the MA-ME process does have that flexibility and therefore requires three Euler angles. In the Euler angle parameterization, a rotation angle and axis defines an individual rotation, and the concatenation of three rotations can produce any desired orientation. Although a minimum representation of orientation, Euler angles have issues with numerical stability and the poorly shaped design space is difficult to optimize, often resulting in convergence to local minima. In order to represent any orientation with three rotations, sequential rotations cannot act on the same axis. This results in twelve (12) possible sets of rotation angles that can be used; according to various embodiments, the Y-Z-X set was selected, but similar performance is expected from all of the sets. The corresponding rotation matrix is shown in Eq. 4 where θ, ϕ, and are the rotation angles about axes Y, Z, and X, respectively. Additionally, C(y) and S(y) are used as shorthand for cos(y) and sin(y), respectively

$$R ( θ , ϕ , ψ ) = [ \begin{matrix}cos ( θ ) & 0 & sin ( θ ) \\ 0 & 1 & 0 \\ - sin ( θ ) & 0 & cos ( θ )\end{matrix} ] * \qquad ( 4 )$$

$$[ \begin{matrix}cos ( ϕ ) & - sin ( ϕ ) & 0 \\ sin ( ϕ ) & cos ( ϕ ) & 0 \\ 0 & 0 & 1\end{matrix} ] * [ \begin{matrix}1 & 0 & 0 \\ 0 & cos ( ψ ) & - sin ( ψ ) \\ 0 & sin ( ψ ) & cos ( ψ )\end{matrix} ]$$

Quaternions.

A quaternion (shown in Eq. (5)) is a noncommutative 4-tuple, and unit length quaternions can be directly related to the axis-angle representation of a rotation. When compared with Euler angles, quaternions are more numerically stable for denoting rotations as they do not have singularity issues. They are also a symmetric representation of rotation (i.e., each component of the quaternion equally influences the resulting rotation). In contrast, the cascading effect of the Euler angle representation creates imbalanced contributions from each angle. Additionally, quaternions only require algebraic operations to calculate rotation matrices, instead of trigonometric functions, which decreases computation time. A rotation matrix can be calculated from a quaternion using Eq. (6).

$$q = {\{ {q}_{w} , {q}_{x} , {q}_{y} , {q}_{z} \}}^{T} \qquad ( 5 )$$

$$R ( q ) = [ \begin{matrix}{q}_{w}^{2} + {q}_{x}^{2} - {q}_{y}^{2} - {q}_{z}^{2} & 2 ( {q}_{x} {q}_{y} - {q}_{w} {q}_{z} ) & 2 ( {q}_{x} {q}_{z} + {q}_{w} {q}_{y} ) \\ 2 ( {q}_{x} {q}_{y} + {q}_{w} {q}_{z} ) & {q}_{w}^{2} - {q}_{x}^{2} + {q}_{y}^{2} - {q}_{z}^{2} & 2 ( {q}_{y} {q}_{z} - {q}_{w} {q}_{x} ) \\ 2 ( {q}_{x} {q}_{z} - {q}_{w} {q}_{y} ) & 2 ( {q}_{y} {q}_{z} + {q}_{w} {q}_{x} ) & {q}_{w}^{2} - {q}_{x}^{2} - {q}_{y}^{2} + {q}_{z}^{2}\end{matrix} ] \qquad ( 6 )$$

In order to represent a pure rotation, the quaternion must be of unit length. Otherwise, when executing the TO algorithm, the elastic matrix will be scaled during reorientation, artificially changing the properties of the element. To prevent this, a unit length constraint must be imposed on each element in the design space. This requires a large number of additional constraints, increasing the computational time required for the optimization.

Natural Quaternions.

In order to remove the explicit unit length constraint on each element in the design space, the parameter space can be relaxed to a natural coordinate system. A method of mapping a 2D natural coordinate space to a planar orientation has been previously presented. This can be applied to the quaternion using Eq. (7), where the natural coordinate system (w, x, y, and z) is mapped onto the constrained coordinate system (q_{w}, qₓ, q_{y}, and q_{z}).

$$\{ \begin{matrix}{q}_{w} \\ {q}_{x} \\ {q}_{y} \\ {q}_{z}\end{matrix} \} = \{ \begin{matrix}w \sqrt{1 - \frac{{x}^{2} + {y}^{2} + {z}^{2}}{2} + \frac{{x}^{2} {y}^{2} + {x}^{2} {z}^{2} + {y}^{2} {z}^{2}}{3} - \frac{{x}^{2} {y}^{2} {z}^{2}}{4}} \\ x \sqrt{1 - \frac{{w}^{2} + {y}^{2} + {z}^{2}}{2} + \frac{{w}^{2} {y}^{2} + {w}^{2} {z}^{2} + {y}^{2} {z}^{2}}{3} - \frac{{w}^{2} {y}^{2} {z}^{2}}{4}} \\ y \sqrt{1 - \frac{{w}^{2} + {x}^{2} + {z}^{2}}{2} + \frac{{w}^{2} {x}^{2} + {w}^{2} {z}^{2} + {x}^{2} {z}^{2}}{3} - \frac{{w}^{2} {x}^{2} {z}^{2}}{4}} \\ z \sqrt{1 - \frac{{w}^{2} + {x}^{2} + {y}^{2}}{2} + \frac{{w}^{2} {x}^{2} + {w}^{2} {y}^{2} + {x}^{2} {y}^{2}}{3} - \frac{{w}^{2} {x}^{2} {y}^{2}}{4}}\end{matrix} \} \qquad ( 7 )$$

By limiting the values of w, x, y, and z between −1 and 1, the resulting quaternion is restricted to have a magnitude of ≤1. Although not a minimum parameterization, this method implicitly enforces the unit length constraint and only requires side constraints. While this does allow quaternions of less than unit length, elements in this state would be artificially weaker. The optimization algorithm therefore naturally drives the quaternion to unit length, as that is the state of minimum compliance.

Optimization Formulation for Three-Dimensional Material Orientations

The CFAO problem statement (shown in Eq. (8)) is stated to minimize the compliance of a structure. This is accomplished through a simultaneous optimization of material distribution and orientation, using two design variables for each element in the design space: (i) a pseudo-density and (ii) an Euler angle. Each pseudo-density scales the elastic matrix, defined by the material being printed, between solid and void, and each Euler angle rotates the scaled matrix corresponding to the optimized deposition direction.

$$\begin{matrix}{min}_{ρ , θ} : c ( ρ , θ ) = {\sum }_{k = 1}^{{N}_{lc}} {U}_{k}^{T} K ( ρ , θ ) {U}_{k} \\ subject to : \frac{V ( ρ )}{{V}_{0}} \leq f \\ : K ( ρ , θ ) {U}_{k} = {F}_{k} \\ : 0 < {ρ}_{min} \leq ρ \leq 1 \\ : - \frac{π}{2} \leq θ \leq \frac{π}{2}\end{matrix} \qquad ( 8 )$$

Uₖ is the global displacement vector associated with load case k, K(ρ,θ) is the global stiffness matrix as defined in Eq. (9), and N₁ is the number of load cases experienced by the structure. V(ρ) is the mass of the current solution and V₀ is the mass of a fully dense design space. The ratio of the two calculates a volume fraction, which must be less than or equal to a maximum allowable volume fraction f. Fₖ is the forcing vector associated with load case k acting on the design space and ρₘᵢₙ is the minimum allowable element pseudo-density.

$$K ( ρ , θ ) = {\sum }_{i = 1}^{{N}_{e}} {ρ}_{i}^{η} {L}_{i}^{T} \int \int {\int }_{{Ω}_{i}} ( {B}^{T} {T}_{i}^{T} ( {θ}_{i} ) {E}_{0} {T}_{i} ( {θ}_{i} ) B ) \partial {Ω}_{i} {L}_{i} \qquad ( 9 )$$

Nₑ is the number of elements in the design space and Ωᵢ is the volume of element i. Lᵢ is the locator matrix that places the element stiffness matrix into the global stiffness matrix, and B is the strain-displacement matrix for the element. The strain transformation matrix Tᵢ(θᵢ) can be written in terms of the rotation matrix Rᵢ(θᵢ) using Eq. 10.

$${T}_{i} = [ \begin{matrix}{l}_{1}^{2} & {m}_{1}^{2} & {n}_{1}^{2} & {l}_{1} {m}_{1} & {m}_{1} {n}_{1} & {n}_{1} {l}_{1} \\ {l}_{2}^{2} & {m}_{2}^{2} & {n}_{2}^{2} & {l}_{2} {m}_{2} & {m}_{2} {n}_{2} & {n}_{2} {l}_{2} \\ {l}_{3}^{2} & {m}_{3}^{2} & {n}_{3}^{2} & {l}_{3} {m}_{3} & {m}_{3} {n}_{3} & {n}_{3} {l}_{3} \\ 2 {l}_{1} {l}_{2} & 2 {m}_{1} {m}_{2} & 2 {n}_{1} {n}_{2} & {l}_{1} {m}_{2} + {l}_{2} {m}_{1} & {m}_{1} {n}_{2} + {m}_{2} {n}_{1} & {n}_{1} {l}_{2} + {n}_{2} {l}_{1} \\ 2 {l}_{2} {l}_{3} & 2 {m}_{2} {m}_{3} & 2 {n}_{2} {n}_{3} & {l}_{2} {m}_{3} + {l}_{3} {m}_{2} & {m}_{2} {n}_{3} + {m}_{3} {n}_{2} & {n}_{2} {l}_{3} + {n}_{3} {l}_{2} \\ 2 {l}_{3} {l}_{1} & 2 {m}_{3} {m}_{1} & 2 {n}_{3} {n}_{1} & {l}_{3} {m}_{1} + {l}_{1} {m}_{3} & {m}_{3} {n}_{1} + {m}_{1} {n}_{3} & {n}_{3} {l}_{2} + {n}_{1} {l}_{3}\end{matrix} ] \qquad ( 10 )$$

E₀ is the matrix of elastic constants describing the fully dense material, and η is the SIMP penalty factor.

The configuration of design variables used by CFAO can be extended to allow for 3D orientations by changing the definition of the transformation matrix in Eq. (9) to incorporate a 3D rotation instead of a strictly XY-planar one. Although three different 3D orientation parameterizations are discussed herein, the general problem statement remains the same. The design variable vector can be partitioned into pseudo-density design variables, ρ, and orientation design variables, Q (Eq. 11). The corresponding full problem statement is shown in Eq. (8) and the definition of the global stiffness matrix is given in Eq. (9). The details of Q change depending on the chosen orientation parameterization. The specific problem formulation for each orientation parameterization is provided in the supplemental equation section below.

$$x = {\{ {ρ}^{T} , {Q}^{T} \}}^{T} \qquad ( 11 )$$

$$\begin{matrix}{min}_{x} : c ( x ) = {\sum }_{k = 1}^{{N}_{lc}} {U}_{k}^{T} K ( x ) {U}_{k} \\ subject to : \frac{V ( ρ )}{{V}_{0}} \leq f \\ : K ( x ) {U}_{k} = {F}_{k} \\ : 0 < {ρ}_{min} \leq ρ \leq 1 \\ : {Q}^{-} \leq Q \leq {Q}^{+}\end{matrix} \qquad ( 12 )$$

$$K ( x ) = {\sum }_{i = 1}^{{N}_{e}} {ρ}_{i}^{η} {L}_{i}^{T} \int \int {\int }_{{Ω}_{i}} ( {B}^{T} {T}_{i}^{T} ( {Q}_{i} ) {E}_{0} {T}_{i} ( {Q}_{i} ) B ) \partial {Ω}_{i} {L}_{i} \qquad ( 13 )$$

Q⁻ and Q⁺ are the lower and upper bounds on the orientation design variables, respectively. ρᵢ and Qᵢ are the pseudo-density and the vector of orientation variables associated with element i, respectively. The specific form of Rᵢ(Qᵢ), and consequently Tᵢ(Qᵢ), is determined by the selected orientation parameterization.

Sensitivity Analysis.

Gradients of the compliance objective function are calculated using two different equations depending on the type of variable: (i) pseudo-density design variables (Eq. (14)) and (ii) orientation design variables (Eq. (15)). Regardless of the orientation parameterization used, the general forms of the gradients remain the same. As an example, specific gradient equations are provided for the Euler angle parameterization in the Supplemental Equation Section below. Due to the decoupled nature of the elements in the design space, the sensitivity calculations can be performed at the element level.

$$\frac{\partial c}{\partial {ρ}_{i}} = - η {ρ}_{i}^{η - 1} {\sum }_{k = 1}^{{N}_{lc}} {u}_{k , i}^{T} \int \int {\int }_{{Ω}_{i}} ( {B}^{T} {T}_{i}^{T} ( {Q}_{i} ) {E}_{0} {T}_{i} ( {Q}_{i} ) B ) \partial {Ω}_{i} {u}_{k , i} \qquad ( 14 )$$

$$\frac{\partial c}{\partial {Q}_{i , j}} = \qquad ( 15 )$$

$$- {ρ}_{i}^{η} {\sum }_{k = 1}^{{N}_{lc}} {u}_{k , i}^{T} \int \int {\int }_{{Ω}_{i}} ( {B}^{T} ( \frac{\partial {{T}_{i} ( {Q}_{i} )}^{T}}{\partial {Q}_{i , j}} {E}_{0} {T}_{i} ( {Q}_{i} ) + {{T}_{i} ( {Q}_{i} )}^{T} {E}_{0} \frac{\partial {T}_{i} ( {Q}_{i} )}{\partial {Q}_{i , j}} ) B ) \partial {Ω}_{i} {u}_{k , i}$$

uₖ,i is the nodal displacement vector associated with element i for load case k. Qᵢ,j is contained within the vector of orientation design variables associated with element i, Qᵢ.

Supplemental Equation Section

In this section, the general TO problem statement used in this disclosure (given in Eq. 12) is specified in terms of each of the 3D orientation parameterizations. The rotation matrix Rᵢ is a function of the orientation design variable vector (Qi) associated with element i using Equations 4-7. Rᵢ is used to calculate the strain transformation matrix Tᵢ, which modifies the element's elastic matrix as shown in Eq. (13). The equation for Tᵢ is shown in Eq. 10 in terms of a general Ri as defined in Eq. (16).

$${R}_{i} = [ \begin{matrix}{l}_{1} & {m}_{1} & {n}_{1} \\ {l}_{2} & {m}_{2} & {n}_{2} \\ {l}_{3} & {m}_{3} & {n}_{3}\end{matrix} ] \qquad ( 16 )$$

Following are the specific forms of the design variable vector (x), the vector of orientation design variables associated with an element i (Qᵢ), and the full problem statement. For the sake of brevity, the specific forms of the gradient equations (given in general form in Eqs. (14) and (15)) are only shown for the Euler angle parameterization, but all parameterizations follow the same structure.

### Euler Angles

x={ρ^{T},θ^{T},ϕ^{T},ψ^{T}}^{T} (17)

Qᵢ={θᵢ,ϕᵢ,ψᵢ}^{T} (18)

The problem statement (Eq. 19)) remains largely the same as the CFAO problem statement. The main difference is the additional side constraints imposed by the additional rotation angle variables. To prevent a cyclic representation, each rotation angle is held within the bounds [−π/2,π/2]. These bounds are equivalent values in terms of material orientation; the algorithm is allowed to move across the boundary but the value of the variable remains bounded.

$$\begin{matrix}{min}_{x} : c ( x ) = {\sum }_{k = 1}^{{N}_{lc}} {U}_{k}^{T} K ( x ) {U}_{k} \\ subject to : \frac{V ( ρ )}{{V}_{0}} \leq f \\ : K ( x ) {U}_{k} = {F}_{k} \\ : 0 < {ρ}_{min} \leq ρ \leq 1 \\ : - \frac{π}{2} \leq θ \leq \frac{π}{2} \\ : - \frac{π}{2} \leq ϕ \leq \frac{π}{2} \\ : - \frac{π}{2} \leq ψ \leq \frac{π}{2}\end{matrix} \qquad ( 19 )$$

$$\frac{\partial c}{\partial {ρ}_{i}} = - {ηρ}_{i}^{η - 1} {\sum }_{k = 1}^{{N}_{lc}} {u}_{k , i}^{T} \int \int {\int }_{{Ω}_{i}} ( {B}^{T} {T}_{i}^{T} ( {Q}_{i} ) {E}_{0} {T}_{i} ( {Q}_{i} ) B ) \partial {Ω}_{i} {u}_{k , i} \qquad ( 20 )$$

$$\frac{\partial c}{\partial {θ}_{i}} = \qquad ( 21 )$$

$$- {ρ}_{i}^{η} {\sum }_{k = 1}^{{N}_{lc}} {u}_{k , i}^{T} \int \int {\int }_{{Ω}_{i}} ( {B}^{T} ( \frac{\partial {{T}_{i} ( {Q}_{i} )}^{T}}{\partial {θ}_{i}} {E}_{0} {T}_{i} ( {Q}_{i} ) + {{T}_{i} ( {Q}_{i} )}^{T} {E}_{0} \frac{\partial {T}_{i} ( {Q}_{i} )}{\partial {θ}_{i}} ) B ) \partial {Ω}_{i} {u}_{k , i}$$

$$\frac{\partial c}{\partial {ϕ}_{i}} = \qquad ( 22 )$$

$$- {ρ}_{i}^{η} {\sum }_{k = 1}^{{N}_{lc}} {u}_{k , i}^{T} \int \int {\int }_{{Ω}_{i}} ( {B}^{T} ( \frac{\partial {{T}_{i} ( {Q}_{i} )}^{T}}{\partial {ϕ}_{i}} {E}_{0} {T}_{i} ( {Q}_{i} ) + {{T}_{i} ( {Q}_{i} )}^{T} {E}_{0} \frac{\partial {T}_{i} ( {Q}_{i} )}{\partial {ϕ}_{i}} ) B ) \partial {Ω}_{i} {u}_{k , i}$$

$$\frac{\partial c}{\partial {ψ}_{i}} = \qquad ( 23 )$$

$$- {ρ}_{i}^{η} {\sum }_{k = 1}^{{N}_{lc}} {u}_{k , i}^{T} \int \int {\int }_{{Ω}_{i}} ( {B}^{T} ( \frac{\partial {{T}_{i} ( {Q}_{i} )}^{T}}{\partial {ψ}_{i}} {E}_{0} {T}_{i} ( {Q}_{i} ) + {{T}_{i} ( {Q}_{i} )}^{T} {E}_{0} \frac{\partial {T}_{i} ( {Q}_{i} )}{\partial {ψ}_{i}} ) B ) \partial {Ω}_{i} {u}_{k , i}$$

Quaternions

x={ρ^{T},q_{w}^{T},qₓ^{T},q_{y}^{T},q_{z}^{T}}^{T} (24)

Qᵢ={q_{w,i},q_{x,i},q_{y,i},q_{z,i}}^{T} (25)

The quaternion parameterization necessitates a unit length constraint placed on each element in the design space. This is reflected in Eq. (24).

$$\begin{matrix}{min}_{x} : c ( x ) = {\sum }_{k = 1}^{{N}_{lc}} {U}_{k}^{T} K ( x ) {U}_{k} \\ subject to : \frac{V ( ρ )}{{V}_{0}} \leq f \\ : K ( x ) {U}_{k} = {F}_{k} \\ : \vert {Q}_{i} \vert = 1 ∀ i = 1 , 2 , 3 … {N}_{e} \\ : 0 < {ρ}_{min} \leq ρ \leq 1 \\ : - 1 \leq {q}_{w} \leq 1 \\ : - 1 \leq {q}_{x} \leq 1 \\ : - 1 \leq {q}_{y} \leq 1 \\ : - 1 \leq {q}_{z} \leq 1\end{matrix} \qquad ( 26 )$$

Natural Quaternions

$$x = {\{ {ρ}^{T} , {w}^{T} , {x}^{T} , {y}^{T} , {z}^{T} \}}^{T} \qquad ( 27 )$$

$${Q}_{i} = {\{ {w}_{i} , {x}_{i} , {y}_{i} , {z}_{i} \}}^{T} \qquad ( 28 )$$

$$\begin{matrix}{min}_{x} : c ( x ) = {\sum }_{k = 1}^{{N}_{lc}} {U}_{k}^{T} K ( x ) {U}_{k} \\ subject to : \frac{V ( ρ )}{{V}_{0}} \leq f \\ : K ( x ) {U}_{k} = {F}_{k} \\ : 0 < {ρ}_{min} \leq ρ \leq 1 \\ : - 1 \leq w \leq 1 \\ : - 1 \leq x \leq 1 \\ : - 1 \leq y \leq 1\end{matrix} \qquad ( 29 )$$

Algorithm Validation

Three example problems were used to validate the presented TO formulation and make comparisons between the three orientation parameterizations in terms of (i) iterations to convergence, (ii) final compliance, and (iii) mesh convergence. For comparison, a CFAO algorithm is also executed for each example problem.

A 2.5D MBB beam structure is used to validate the functionality of the presented formulation. The load case is shown in FIG. 17, leveraging the symmetry around the central XZ-plane to reduce the number of required elements. Due to this planar loading case, the 3D orientation parameterizations are not expected to outperform the CFAO algorithm. Additionally, the Euler angle parameterization is expected to have less difficulty with local minima and converge to a similar result as the quaternion parameterizations.

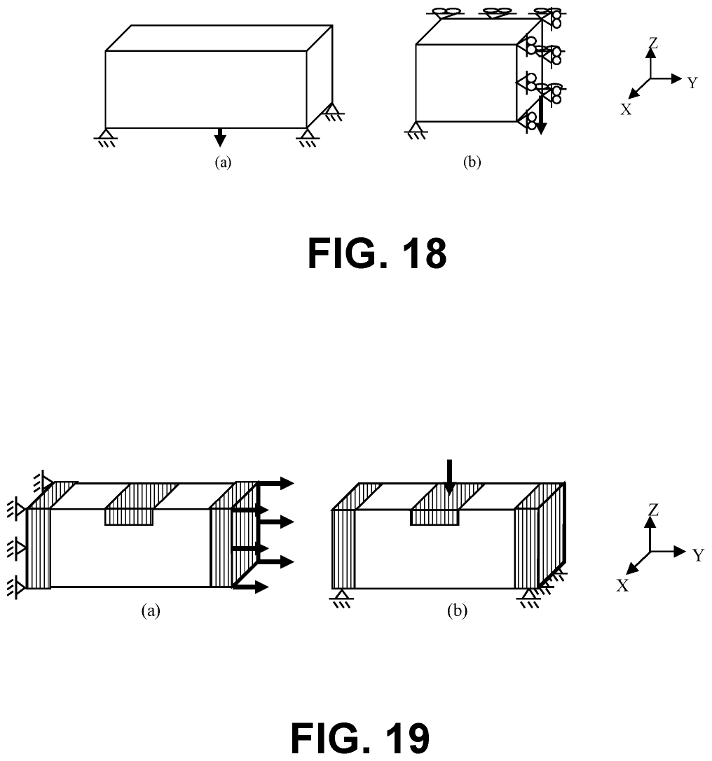

The 3D Wheel problem is used to compare the parameterizations in terms of their ability to follow 3D load paths. The load case is shown in FIG. 18, and the symmetry is leveraged across both the central XZ- and YZ-planes. The aspect ratio and the fixed corner nodes create a non-planar load case. As such, the 3D orientations are expected to demonstrate significant improvement in compliance over the CFAO algorithm, and the quaternion parameterizations are expected to converge in fewer iterations than the Euler angle parameterization.

A multi-loading case is then used to evaluate the algorithm's mesh convergence in regards to optimizing multi-loaded structures and the performance in fixed-density regions. The first loading case is pure tension along the Y-axis, and the second is three-point bending in the YZ-plane as shown in FIG. 19. Fixed density regions (marked in gray) are allotted in anticipation of test fixturing; the algorithm is only able to optimize the orientation in those regions.

Implementation.

The presented TO algorithm was implemented in MATLAB® 2018a, using the Method of Moving Asymptotes (MMA) as the optimizer. To prevent mesh instabilities (e.g., mesh dependency and checkerboard patterning) and to produce nearly binary solutions, the Heaviside projection method was implemented for the pseudo-density design variables. A few modifications were made to the default parameters of the MMA algorithm to create a more conservative subproblem: move was decreased from 0.5 to 0.3, asyinit was changed from 0.5 to 0.3/(β+1), and asyincr was decreased from 1.2 to 1.1. Finally, due to the highly curved orientation design spaces, the minimum asymptote multiplier was decreased from 0.01 to 2.5*10⁻⁴ to allow the optimizer to move closer to the local minimum.

The initial conditions for the element orientations were driven by the CFAO algorithm to allow orientation variation in the YZ-plane and were kept constant between the different parameterizations. The pseudo-density of each element was initialized to the allowable volume fraction, 0.2; in the multi-load case, the fixed-density elements were set to 0.5. The continuation method was also implemented to promote convergence to the global minimum. According to various embodiments, the SIMP penalty factor was iteratively increased from 1 to 3 by an increment of 0.1 after the MMA algorithm executed 30 iterations. A termination criteria using the first-order necessary condition was created using a tolerance of 10⁻⁴, but while all problems converged, none satisfied that criteria. The Heaviside filter radius (rₘᵢₙ) is set to 1.4 voxels relative to the size of the coarsest mesh and scales linearly as the mesh is refined. Other optimization parameters are described in Table 2, and the mesh sizes used to evaluate convergence for each problem are given in Table 3.

TABLE 2

| Variable | Value | Description |
|---|---|---|
| f | 0.2 | Allowable volume fraction |
| L | 1 | Point load magnitude |
| rₘᵢₙ | 1.4 | Heaviside density filter radius |
| β | 2 | Heaviside approximation curvature parameter |
| E_{1, 1} | 10 | Young's modulus for deposition direction |
| E_{2, 2} | 4 | Young's modulus for intra-layer bonds |
| E_{3, 3} | 1 | Young's modulus for inter-layer bonds |
| v | 0.35 | Isotropic Poisson's ratio |
| G | 1.4 | Isotropic shear modulus |

TABLE 3

| MBB Beam | Wheel | Multi-load |
|---|---|---|
| 1 × 60 × 20 | 15 × 15 × 15 | 1 × 120 × 40 |
| 1 × 120 × 40 | 30 × 30 × 30 | 1 × 240 × 80 |
| 1 × 240 × 80 | 45 × 45 × 45 | 1 × 480 × 160 |
| 1 × 480 × 160 | 60 × 60 × 60 | 1 × 960 × 320 |
| 1 × 960 × 320 | — | — |

Material Properties.

For homogeneous printed acrylonitrile butadiene styrene (ABS), the tensile properties resulting from MA-ME are independent of the build direction. That is to say, a material deposition at any arbitrary orientation will have the same mechanical performance as one printed in the XY-plane (i.e., by more typical 3-DoF deposition). Therefore, the elastic matrix does not have any orientation dependence; the deposition direction within an element only changes the orientation of the elastic matrix in the global coordinate system, not the value in the local coordinate system. According to various embodiments, an orthotropic elastic matrix is used to model the properties resulting from the ME process, which is kept constant throughout the example problems. The matrix is derived from the material properties listed in Table 3.

Visualizations.

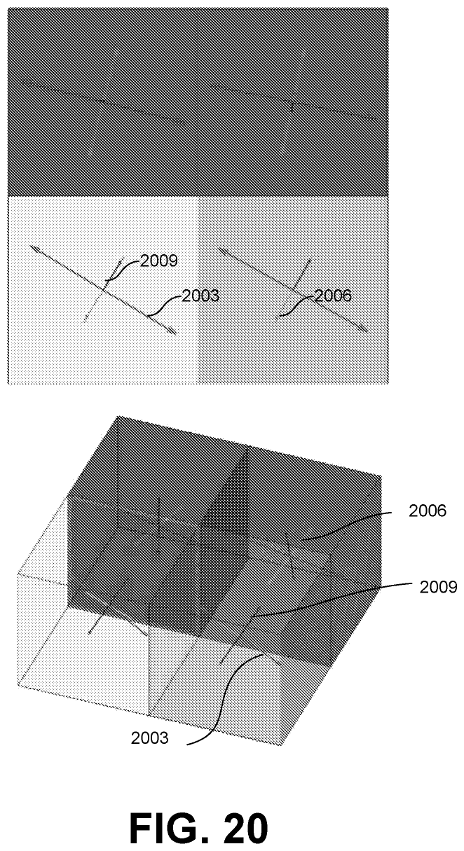

The output from the TO algorithm is a discretized geometry, where each element has an orientation associated with it. Due to the information density, two plotting techniques are leveraged as described below. For visual clarity, elements with a pseudo-density of ρᵢ<0.25 are not displayed in either visualization. For small numbers of elements, it is useful to display all of the information together, as shown in FIG. 20. The shading represents the relative density, where darker shading represents more solid elements, and the orientations are displayed using vectors within each element. Black elements typically represent fully dense regions, but in FIG. 20, the element shading is scaled such that fully dense elements are represented by a dark gray.

This is done to promote visibility of the material orientations. The long arrows 2003 denote the deposition (E1,1) direction, the second arrows 2006 denote the intra-layer bond (E2,2) direction, and third (short) arrows 2009 denote the inter-layer bond (E3,3) direction.

Messerschmitt-Bölkow-Blohm Beam Results.

With the exception of the Euler angle parameterization, each of the resulting topologies are qualitatively similar regardless of the orientation parameterization. The main truss leading from the point of load to the support occupies the majority of the allowed volume fraction, and similar supporting features appear beneath the main truss. The Euler angle parameterization deviates from this design with an additional secondary supporting truss but with a reduced volume fraction allotted to each of those supporting trusses. For each parameterization, the E1,1 direction follows the truss direction (as predicted by Michell's truss theorem), and the E3,3 direction is largely removed from the load paths.

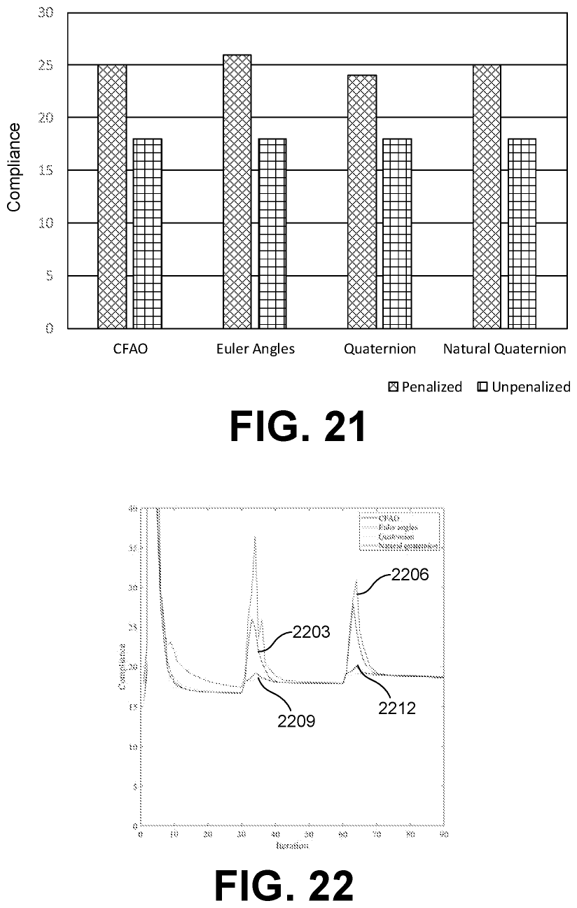

The objective function evaluations, plotted in FIG. 21, demonstrated that the 3D material orientation parameterizations produced structures with similar final compliance values to the CFAO algorithm. This similarity is largely attributed to the problem's planar loading case, which does not leverage the advantages of a 3D material orientation.

The increase in the penalized evaluation of the Euler angle design is likely due to the increased use of intermediate densities in the secondary truss structures. Although all of the parameterizations arrived at similar final compliance values, the rate of convergence differed between the parameterizations during optimization. The first three continuation cycles are shown in FIG. 22. As evidenced in the figure, the Euler angle parameterization 2206 converged the slowest on each continuation cycle, requiring approximately eight additional iterations to converge within 1% of the final objective function value. After the first cycle though, the CFAO parameterization 2203 also demonstrated difficulties during convergence relative to the quaternion parameterizations (e.g., quaternion 2206, natural quaternion 2209), requiring approximately two additional iterations to converge. This slower convergence is likely due to the poorly shaped design spaces of the CFAO and Euler angle parameterizations. Even though the quaternion parameterizations require additional design variables to denote orientations, the additional iterations required to converge at each continuation cycle would increase computation time for large optimization problems.

Wheel Results.

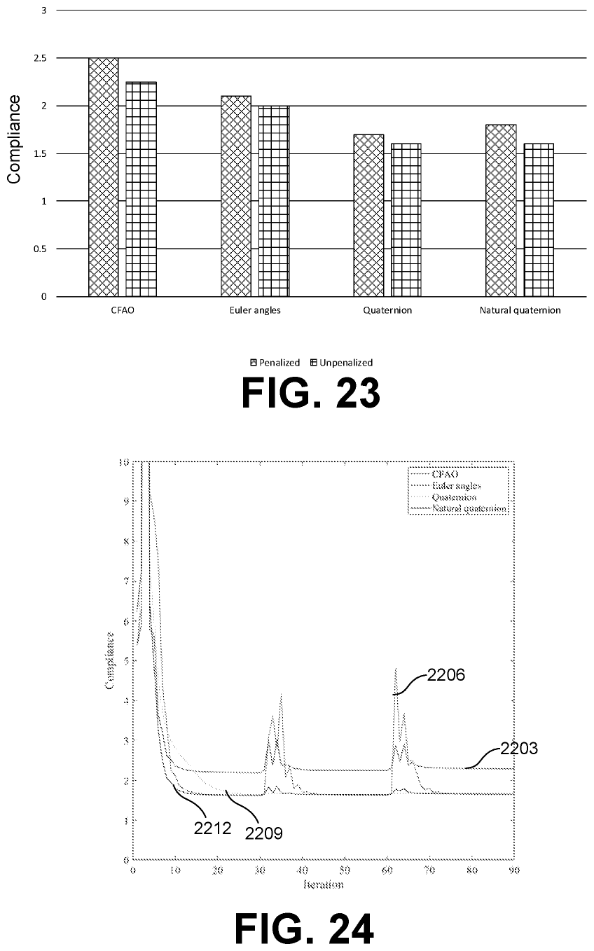

Qualitatively, the results of the 3D orientation parameterizations have similar geometric features; each contains curved features moving from the point of support to the point of load at the intersection of the planes of symmetry. While the 3D parameterizations produced symmetric final structures, as expected from the double-symmetric load case, the CFAO algorithm preferentially distributed material within the plane of variation (the YZ-plane). This deficiency is also reflected in the final compliance values, as shown in FIG. 23; while the quaternion parameterizations achieved similar final values, the CFAO algorithm produced a structure with a 38% increased final compliance relative to the natural quaternion result. The Euler angle parameterization also demonstrated difficulty with this loading case, producing a structure with 24% increased compliance. This is likely due to the orientations converging to local minima.

The Euler angle and CFAO parameterizations also required an increased number of iterations to converge, as shown in FIG. 24. Although the explicit quaternion 2209 took nearly the full 30 iterations to converge on the first cycle, the Euler angle parameterization 2206 and CFAO parameterization 2203 required approximately five additional iterations to converge on subsequent cycles than the explicit quaternion parameterization 2209 and natural quaternion parameterization 2212. The increased number of iterations, coupled with the oscillating objective function evaluations, demonstrates a difficulty converging.

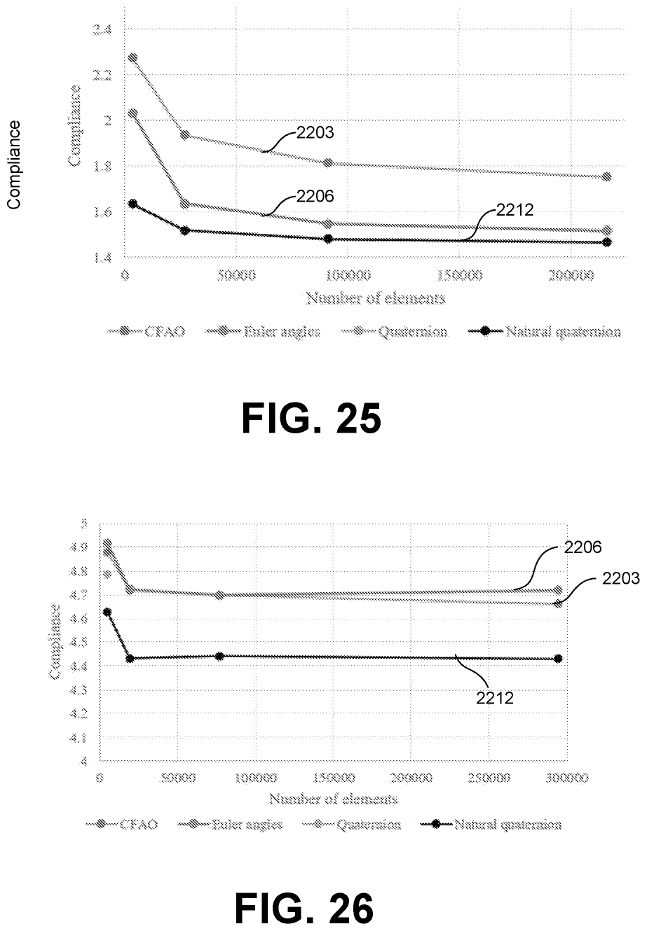

In terms of mesh convergence, the final objective function evaluations for each of the parameterizations are plotted in FIG. 25 against the number of elements in the design space. Due to computational requirements, the explicit quaternion parameterization was only able to be executed for the coarsest mesh size (15×15×15 or 3375 elements). It is also important to note that the single data point for the explicit quaternion parameterization directly overlaps with the natural quaternion parameterization. As seen, the final compliance values for the other parameterizations do converge by the finest mesh size, but the natural quaternion produces the structure with the minimum compliance at each mesh size.

Multi-Load Results.

The multi-load case is used to evaluate the algorithm's mesh convergence for a complex loading condition. According to the natural quaternion results, the main features of the geometry do not change with increasing mesh refinement, but the figures do demonstrate a settling of the secondary features between the mesh size of 1×480×160 and the mesh size of 1×960×320. Although there is some variation in the optimized orientations between the mesh size of 1×480×160 and the mesh size of 1×960×320, the final compliance values (plotted in FIG. 26) show little variation after the first mesh refinement. There are qualitative differences between geometric features; while each parameterization features the same main density features, the quaternion result does not exhibit other secondary features. Although the placement of those supporting features varies between the CFAO, Euler angle, and natural quaternion, the main difference in final compliance lies in the optimized orientations. The CFAO and Euler angle results seem to have converged to local minima, as exhibited by the unaligned orientations near the bottom of the two results. The gradients of the corresponding design variables are below 1-10, well below the convergence criteria, but the orientations themselves do not agree with expectation (i.e., Michell's truss theorem).

In the case of the explicit quaternion result, the increased compliance relative to the natural quaternion result is attributed to the more restricted orientation design space. During each iteration, the MMA algorithm can only make a small step in the orientation design space in order to maintain the unit length constraint. As such, the density features are likely developed ahead of the orientation field, limiting its optimality

Computational Requirements.

The optimization time also needs to be considered when dealing with large optimization problems. The parameterizations each have similar computation times relative to the number of elements in the design space with the exception of the explicit quaternion parameterization. For the coarsest Wheel mesh of 3375 elements, the CFAO, Euler angle, and natural quaternion parameterizations took under thirty minutes to complete. The inclusion of explicit unit length constraints in the quaternion parameterization saw the optimization time increase to 32.8 hours. These times are not included for the purposes of benchmarking but as an order-of-magnitude comparison. In addition to increasing the computation time, the inclusion of unit length constraints in the quaternion parameterization also increases the memory requirements. During the execution of the MMA algorithm, multiple non-sparse matrices of size number of constraints by number of design variables must be created. These matrices are therefore of size (Nₑ+1)*(5Nₑ) for the explicit quaternion parameterization and exceed the memory limits for all of the tested meshes that had more than 5000 elements. For large optimization problems, the increased computation time and memory requirement render the explicit quaternion parameterization infeasible.

Towards Integration with Multi-Axis Material Extrusion

The presented TO algorithm represents the first step towards a larger goal of enabling the use of MA-ME (e.g., with the system shown in FIG. 12) to improve the mechanical performance of printed parts. Specifically, the optimized voxel-based geometry and associated orientation field correspond to the optimal build and deposition directions for the printing process. These results can be translated to a set of deposition paths that can be ordered for fabrication. The ordered deposition paths can then be translated to a toolpath describing robot joint trajectories and extrusion commands.

Propagating Deposition Paths.

There are existing techniques for generating MA toolpaths, but they are restricted to the fabrication of geometries with deposition directions that lie on stratified surfaces (i.e., geometries with orientation fields that can be decomposed into a series of surfaces). The results demonstrated the present disclosure do not have orientation fields that are easily decomposed into surfaces. Therefore, a novel deposition path planning technique is required to generate deposition paths that follow the optimized orientation field. With this goal in mind, a deposition path planning algorithm is built on streamline placement algorithms, commonly used in the field of computational fluid dynamics. The algorithm leverages the concept of iterative advection to iteratively place deposition paths into the orientation field by directly following the orientation field. As a result, the produced deposition paths demonstrate strong alignment to the input orientation field.

Ordering Deposition Paths.

Due to the non-planar nature of the orientation fields resulting from the presented TO algorithm, the deposition paths aligned to these orientation fields will also be non-planar. It cannot be assumed that all of the material will be below the deposition head (as in typical planar deposition); the deposition paths cannot necessarily be printed in ascending order. If the deposition paths are not ordered properly, it is likely that the deposition head will collide with previously deposited material.

To achieve a collision-free toolpath, precedence constraints must first be established between the deposition paths. For instance, if the deposition head would collide with deposition path B while fabricating path A, path A must be printed before path B. By explicitly determining and satisfying these precedence constraints, the resulting toolpath is assured to be collision-free.

Manufacturing Constraints.

As formulated, the optimization problem does not consider the manufacturing constraints, specifically collision concerns, imposed by the MA-ME process. In particular, collisions between the deposition head and (i) the environment (e.g., the build platform) and (ii) previously deposited material (e.g., regions exhibiting collisions) should be avoided by the TO algorithm. Otherwise, it may not be possible to fabricate portions of the structure.

The present disclosure presents a method for the simultaneous optimization of material distribution and orientation in full 3D to enable MA-ME by extending a CFAO algorithm to optimize for 3D orientation design spaces. CFAO has previously been demonstrated to be effective for planar orientation variation and for non-planar fiber orientation, but these methods do not have enough flexibility in the orientation design space to properly model the MA-ME process. While the distribution of design variables used in CFAO (i.e., one set defining the material distribution and another defining the orientation) can scale up to 3D, the selection of the orientation parameterization has a large impact on the performance and efficiency of the TO algorithm. Therefore, three parameterizations of 3D orientations were explored: (i) Euler angles, (ii) quaternions, and (iii) natural quaternions.

These parameterizations were compared through two established minimum compliance example problems, the MBB beam and the Wheel problem, as well as a multi-load case featuring pure tension and three-point bending. The final objective functions, iterations to convergence, and mesh convergence were compared for each parameterization, using the CFAO algorithm as a baseline.

The MBB beam problem featured a planar load case, and the plane of allowed orientation variation for the CFAO algorithm was chosen to be in the same plane as the load case. As hypothesized, all three of the 3D parameterizations and the CFAO algorithm arrived at similar final objective function values. The final topologies qualitatively agreed with literature by showing the characteristic density paths, and the strongest directions (E1,1) aligned between the point of load and points of support. The Wheel problem was a true 3D mesh and loading case, using (at the coarsest) a mesh of 15×15×15 elements. In this case, the CFAO algorithm was only able to follow the YZ-component of the load paths, as that was the allowable plane of variation. In contrast, the 3D orientation parameterizations demonstrated significant improvement in E1,1 alignment between the point load and supporting locations. The final objective function values of the quaternion parameterizations demonstrated an approximately 38% improvement over that of the CFAO algorithm. The Euler angle parameterization demonstrated similar difficulties, converging to a solution with 24% increased compliance. In this case, the increased compliance is attributed to convergence to a local minima in the orientation design space.

In the multi-load case, the Euler angle and the CFAO algorithm produced similarly compliant structures, but the natural quaternion parameterization outperformed all of the other parameterizations of the orientation design space. This is attributed to (i) the Euler angle and CFAO parameterizations converging to local minima and (ii) the inflexibility of the explicit quaternion parameterization. There is a limited range of motion during the optimization of a unit length quaternion, which restricts flexibility at each iteration.

The 3D parameterizations also saw differentiation in terms of the number of iterations required to converge to a solution; the Euler angle parameterization required approximately six additional iterations for each continuation cycle relative to the explicit and natural quaternion parameterizations. Additionally, the quaternion parameterization required the inclusion of a unit length constraint for each element in the design space. This sharply increased the computation time; while the other parameterizations took less than thirty minutes each to finish the 3D Wheel problem with a 15×15×15 mesh, the quaternion parameterization took approximately 32.8 hour. As the mesh is refined, the computation time and memory requirements of the quaternion parameterization became prohibitive. The presented TO algorithm serves as the first step towards the larger goal of enabling MA-ME for the fabrication of strong, lightweight geometries. The optimized orientation fields can be directly related to the desired deposition and build (i.e., tool head) directions throughout the part. These voxels can be continuously connected with deposition paths, and the paths can be ordered for collision-free deposition. Although the MA-ME process imparts significant freedom in terms of deposition placement, manufacturing constraints are still necessary to ensure a printable result.

Illustrative examples of various embodiments of the present disclosure are set forth below. Additional embodiments of the present disclosure are discussed in the preceding paragraphs. Accordingly, the scope of the present disclosure should not be construed as being limited to the following clauses:

Clause 1. A method for generating a toolpath for layer-less multi-axis deposition, comprising: determining, by at least one computing device, an object geometry for an object having an orientation field; defining, by the at least one computing device, a plurality of roads and a plurality of build directions corresponding to the plurality of roads, the plurality of roads and the plurality of build directions being defined according to the object geometry, and the plurality of the roads being defined to follow the orientation field; determining, by the at least one computing device, a collision-free order for depositing the plurality of roads; generating, by the at least one computing device, the toolpath for printing the object geometry based at least in part on the object geometry, the plurality of roads, and the collision-free order; and transmitting, by the at least one computing device, the toolpath to a printer for printing.

Clause 2. The method of clause 1, further comprising defining, by the at least one computing device, a support structure based at least in part on the object geometry and the orientation field, wherein defining the support structure comprises identifying one or more unsupported regions in the object geometry, the support structure being defined according to the one or more unsupported regions in the object geometry.

Clause 3. The method of clause 2, wherein the support structure comprises a substrate for depositing a material onto to form the object.

Clause 4. The method of any one of clauses 1 to 3, wherein a respective build direction for a respective road is perpendicular to a road direction of the respective road.

Clause 5. The method of any one of clauses 1 to 4, wherein determining the collision-free order is based at least in part one or more precedence constraints, a road continuity factor, and a minimization of deposition head movement.

Clause 6. The method of any one of clauses 1 to 5, wherein determining the collision-free order further comprises at least one of reorienting build directions of unordered roads or removing one or more unordered roads in response to failing to identify at least one collision-free road.

Clause 7. The method of any one of clauses 1 to 6, wherein determining the collision-free order further comprises identifying a subset of collision-free roads based at least in part on a comparison of a respective collision volume for a given road with the respective volume for all roads, the collision-free order being based at least in part on the identified subset of collision-free roads.

Clause 8. The method of any one of clauses 1 to 7, wherein the orientation field is bi-directional.

Clause 9. A system, comprising: at least one computing device; at least one application executable on the at least one computing device, wherein, when executed the at least one application causes the at least one computing device to at least: determine an object geometry and orientation field for an object; define a support structure based at least in part on the object geometry and the orientation field; define a plurality of roads and a plurality of build directions corresponding to the plurality of roads, the plurality of roads and the plurality of build directions being defined according to the object geometry and the support structure, and the plurality of the roads being defined to follow the orientation field; determine a collision-free order for depositing the plurality of roads; generate a toolpath for printing the object geometry based at least in part on the support structure, the object geometry, the plurality of roads, and the collision-free order; and transmit the toolpath to a printer for printing.

Clause 10. The system of clause 9, wherein defining the support structure comprises identifying one or more unsupported regions in the object geometry, the support structure being defined according to the one or more unsupported regions in the object geometry.

Clause 11. The system of clause 9 or clause 10, wherein the support structure comprises a substrate for depositing a material onto to form the object.

Clause 12. The system of any one of clauses 9 to 11, wherein a respective build direction for a respective road is perpendicular to a road direction of the respective road.

Clause 13. The system of any one of clauses 9 to 12, wherein determining the collision-free order is based at least in part one or more precedence constraints, a road continuity factor, and a minimization of deposition head movement.

Clause 14. The system of any one of clauses 9 to 13, wherein determining the collision-free order further comprises at least one of reorienting build directions of unordered roads or removing one or more unordered roads in response to failing to identify at least one collision free road.

Clause 15. The system of any one of clauses 9 to 14, wherein determining the collision-free order further comprises identifying a subset of collision-free roads based at least in part on a comparison of a respective collision volume for a given road with the respective volume for all roads, the collision-free order being based at least in part on the identified subset of collision-free roads.

Clause 16. The system of any one of clauses 9 to 15, wherein the orientation field is bi-directional.

Clause 17. A method, comprising: generating an ordered toolpath associated with a given geometry based at least in part on a plurality of roads associated with the given geometry, and a collision-free order for depositing the plurality of roads, the plurality of roads being defined to follow an orientation field of the given geometry; and transmitting the toolpath to a multi-axis printer for printing.

Clause 18. The method of clause 17, further comprising defining a support structure for a substrate to support material deposited for the given geometry, the support structure being defined according to unsupported regions associated with the given geometry.

Clause 19. The method of clause 17 or clause 18, further comprising determining, based at least in part on the given geometry, the plurality of roads, a respective build direction for individual roads of the plurality of roads, and a respective road direction of the individual roads, wherein the respective build direction is perpendicular to the respective road direction

Clause 20. The method of any one of clauses 17 to 19, further comprising determining the collision-free order for the plurality of roads based at least in part on one or more constrained, a road continuity factor, and a minimization of deposition head movement.

Clause 21. A method for generating a toolpath for layer-less multi-axis deposition comprising: defining, by at least one computing device, one or more design criteria and one and one or more manufacturing constraints associated with a three-dimensional (3D) printing of an object; determining, by the at least one computing device, an optimized topology and an orientation field associated with an object geometry of the object based at least in part on the one or more design criteria and the one or more manufacturing constraints; generating, by the at least one computing device, a toolpath for printing the object based at least in part on the optimized topology and the orientation field; and transmitting, by the at least one computing device, the toolpath to a 3D printer for printing.

Clause 22. The method of clause 21, wherein the one or more design criteria comprises at least one of a printing material, a thermal dissipation associated with the printing material, a printing material strength, a printing material weight, a printing material stiffness, or an electrical conductance associated with the printing material.

Clause 23. The method of clause 21 or clause 22, wherein the one or more manufacturing constraints are based at least in part on one or more characteristics associated with the 3D printer.

Clause 24. The method of any one of clauses 21 to 23, wherein generating the toolpath comprises defining, by the at least one computing device, a plurality of roads and a plurality of build directions corresponding to the plurality of roads, the plurality of roads and the plurality of build directions being defined according to the object geometry of the object, and the plurality of the roads being defined to follow the orientation field.

Clause 25. The method of clause 24, wherein generating the toolpath further comprises determining, by the at least one computing device, a collision-free order for depositing the plurality of roads.

Clause 26. The method of clause 25, wherein determining the collision-free order is based at least in part one or more precedence constraints, a road continuity factor, and a minimization of deposition head movement.

Clause 27. The method of clause 25 or clause 26, wherein determining the collision-free order further comprises at least one of reorienting build directions of unordered roads or removing one or more unordered roads in response to failing to identify at least one collision-free road.

Clause 28. The method of any one of clauses 25 to 27, wherein determining the collision-free order further comprises identifying a subset of collision-free roads based at least in part on a comparison of a respective collision volume for a given road with the respective volume for all roads, the collision-free order being based at least in part on the identified subset of collision-free roads.

Clause 29. The method of any one of clauses 21 to 28, further comprising defining, by the at least one computing device, a support structure based at least in part on the optimized topology and the orientation field, wherein defining the support structure comprises identifying one or more unsupported regions in the object geometry of the object, the support structure being defined according to the one or more unsupported regions in the object geometry.

Clause 30. The method of clause 29, wherein the optimized topology aligns a material strength of a printing material with one or more anticipated load paths associated with the object geometry.

Clause 31. The method of any one of clauses 21 to 30, wherein the orientation field is bi-directional.

Clause 32. A system, comprising: at least one computing device; and at least one application executable on the at least one computing device, wherein, when executed the at least one application causes the at least one computing device to at least: define one or more design criteria associated with a three-dimensional (3D) printing of an object; determine a material distribution and an orientation field associated with an optimized topology for an object geometry of the object based at least in part on the one or more design criteria; and generate an ordered toolpath associated with a given geometry based at least in part on the orientation field and the material distribution.

Clause 33. The system of clause 32, wherein generating the order toolpath further comprises: defining a support structure based at least in part on the object geometry, the material distribution, and the orientation field; and defining a plurality of roads and a plurality of build directions corresponding to the plurality of roads, the plurality of roads and the plurality of build directions being defined according to the object geometry and the support structure, and the plurality of the roads being defined to follow the orientation field.

Clause 34. The system of clause 33, wherein generating the order toolpath further comprises determining a collision-free order for depositing the plurality of roads.

Clause 35. The system of clause 34, wherein determining the collision-free order is based at least in part one or more precedence constraints, a road continuity factor, and a minimization of deposition head movement.

Clause 36. The system of any one of clauses 12 to 15, wherein the one or more design criteria comprises at least one of a printing material, a thermal dissipation associated with the printing material, an electrical conductance associated with the printing material, or one or more manufacturing constraints.

Clause 37. A method, comprising: determining, via at least one computing device, a material distribution and an orientation field associated with an optimized topology for an object geometry of an object; and generating, via the at least one computing device, an ordered toolpath associated with the object geometry based at least in part on the orientation field and the material distribution.

Clause 38. The method of clause 17, further comprising defining one or more design criteria and one or more manufacturing constraints associated with the printing of the object.

Clause 39. The method of clause 17 or clause 18, further comprising applying the one or more design criteria and the one or more manufacturing constraints to an optimized topology algorithm, the material distribution and the orientation field being an output of the optimized topology algorithm.

Clause 40. The method of any one of clauses 17 to 19, further comprising transmitting the toolpath to a multi-axis printer for printing.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A method for generating a toolpath for layer-less multi-axis deposition comprising:
defining, by at least one computing device, one or more design criteria and one and one or more manufacturing constraints associated with a three-dimensional (3D) printing of an object;
determining, by the at least one computing device, an optimized topology and an orientation field associated with an object geometry of the object based at least in part on the one or more design criteria and the one or more manufacturing constraints;
generating, by the at least one computing device, a toolpath for printing the object based at least in part on the optimized topology and the orientation field; and
transmitting, by the at least one computing device, the toolpath to a 3D printer for printing.

2. The method of claim 1, wherein the one or more design criteria comprises at least one of a printing material, a thermal dissipation associated with the printing material, a printing material strength, a printing material weight, a printing material stiffness, or an electrical conductance associated with the printing material.

3. The method of claim 1, wherein the one or more manufacturing constraints are based at least in part on one or more characteristics associated with the 3D printer.

4. The method of claim 1, wherein generating the toolpath comprises defining, by the at least one computing device, a plurality of roads and a plurality of build directions corresponding to the plurality of roads, the plurality of roads and the plurality of build directions being defined according to the object geometry of the object, and the plurality of the roads being defined to follow the orientation field.

5. The method of claim 4, wherein generating the toolpath further comprises determining, by the at least one computing device, a collision-free order for depositing the plurality of roads.

6. The method of claim 5, wherein determining the collision-free order is based at least in part one or more precedence constraints, a road continuity factor, and a minimization of deposition head movement.

7. The method of claim 5, wherein determining the collision-free order further comprises at least one of reorienting build directions of unordered roads or removing one or more unordered roads in response to failing to identify at least one collision-free road.

8. The method of claim 5, wherein determining the collision-free order further comprises identifying a subset of collision-free roads based at least in part on a comparison of a respective collision volume for a given road with the respective volume for all roads, the collision-free order being based at least in part on the identified subset of collision-free roads.

9. The method of claim 1, further comprising defining, by the at least one computing device, a support structure based at least in part on the optimized topology and the orientation field, wherein defining the support structure comprises identifying one or more unsupported regions in the object geometry of the object, the support structure being defined according to the one or more unsupported regions in the object geometry.

10. The method of claim 9, wherein the optimized topology aligns a material strength of a printing material with one or more anticipated load paths associated with the object geometry.

11. The method of claim 1, wherein the orientation field is bi-directional.

12. A system, comprising:
at least one computing device; and
at least one application executable on the at least one computing device, wherein, when executed the at least one application causes the at least one computing device to at least:
define one or more design criteria associated with a three-dimensional (3D) printing of an object;
determine a material distribution and an orientation field associated with an optimized topology for an object geometry of the object based at least in part on the one or more design criteria; and
generate an ordered toolpath associated with a given geometry based at least in part on the orientation field and the material distribution.

13. The system of claim 12, wherein generating the order toolpath further comprises:
defining a support structure based at least in part on the object geometry, the material distribution, and the orientation field; and
defining a plurality of roads and a plurality of build directions corresponding to the plurality of roads, the plurality of roads and the plurality of build directions being defined according to the object geometry and the support structure, and the plurality of the roads being defined to follow the orientation field.

14. The system of claim 13, wherein generating the order toolpath further comprises determining a collision-free order for depositing the plurality of roads.

15. The system of claim 14, wherein determining the collision-free order is based at least in part one or more precedence constraints, a road continuity factor, and a minimization of deposition head movement.

16. The system of claim 12, wherein the one or more design criteria comprises at least one of a printing material, a thermal dissipation associated with the printing material, an electrical conductance associated with the printing material, or one or more manufacturing constraints.

17. A method, comprising:
determining, via at least one computing device, a material distribution and an orientation field associated with an optimized topology for an object geometry of an object; and
generating, via the at least one computing device, an ordered toolpath associated with the object geometry based at least in part on the orientation field and the material distribution.

18. The method of claim 17, further comprising defining one or more design criteria and one or more manufacturing constraints associated with the printing of the object.

19. The method of claim 17, further comprising applying the one or more design criteria and the one or more manufacturing constraints to an optimized topology algorithm, the material distribution and the orientation field being an output of the optimized topology algorithm.

20. The method of claim 17, further comprising transmitting the toolpath to a multi-axis printer for printing.
